(19) United States
(12) Patent Application Publication
(10) Pub. No.: US 2010/0311606 A1
(43) Pub. Date: Dec. 9, 2010

(54) PHARMACOGENOMIC CELL LINE PANEL AND USE THEREOF

(76) Inventors: Liewei Wang, Rochester, MN (US); Richard M. Weinshilboum, Rochester, MN (US); Liang Li, Rochester, MN (US); Brooke L. Fridley, Rochester, MN (US); Krishna Kalari, Rochester, MN (US); Daniel Schaid, Rochester, MN (US); Matthew M. Ames, Rochester, MN (US)

Correspondence Address: FISH & RICHARDSON P.C. (TC), PO BOX 1022, MINNEAPOLIS, MN, 55440-1022, US

(21) Appl. No.: 12/599,252

(22) PCT Filed: May 7, 2008
(86) PCT No.: PCT/US08/62827

§ 371 Date: Aug. 3, 2010

Related U.S. Application Data
(60) Provisional application No. 60/928,164, filed on May 7, 2007.
(60) Provisional application No. 60/999,164, filed on Oct. 16, 2007.

(51) Int. Cl. C40B 30/04

(52) U.S. Cl. 506/9

(57) ABSTRACT

Materials and methods for evaluating cellular response to therapeutic agents.

### CROSS-REFERENCE TO RELATED APPLICATIONS

This application claims priority from U.S. Provisional Application Ser. Nos. 60/928,164, filed May 7, 2007, and 60/999,164, filed Oct. 16, 2007, both of which are incorporated herein by reference in their entirety.

### STATEMENT AS TO FEDERALLY SPONSORED RESEARCH

This invention was made with government support under grant no. GM061388, awarded by the National Institute of General Medical Sciences, and grant no. CA102701, awarded by the National Cancer Institute. The government has certain rights in the invention.

### TECHNICAL FIELD

This document relates to assessing the potential effect of therapeutics on a subject.

### BACKGROUND

Pharmacogenetics is the study of the role of inheritance in individual variation in response to drugs, nutrients and other xenobiotics, and in this post-genomic era, pharmacogenetics has evolved into pharmacogenomics (Wang et al. (2003) Pharmacogenetics 13:555-64; Weinshilboum and Wang (2004) Nature Rev Drug Discovery 3:739-748; Guttmacher and Collins (2005) JAMA 294:1399-402; and Weinshilboum and Wang (2006) Annu Rev Genomics Hum Genet 7:223-45). Drug response phenotypes that are influenced by inheritance can vary from potentially life-threatening adverse reactions at one of the spectrum to lack of therapeutic efficacy at the other. The ability to determine whether and how a subject will respond to a particular drug can assist medical professionals in determining whether the drug should be administered to the subject, and at what dose.

A major challenge facing this component of individualized medicine is how to identify pharmacogenomically important candidate genes for a variety of drugs—including drugs yet to be developed—in an efficient and scientifically valid fashion. Clinical drug trials are expensive and require large patient populations. Academic centers can find it difficult to contribute to pharmacogenomic studies because of the size, complexity and cost of conducting trials to develop and test novel pharmacogenomic hypotheses. At the same time, the “blockbuster” drug approach that has been the major working model for pharmaceutical companies is increasingly challenged by the concept of “individualized” drug therapy. Thus, there is an increasing need to incorporate pharmacogenomics into drug development and early clinical trials. In addition, there is a great need for a model system that would represent common human genetic variation and that could be used to rapidly test drug response phenotypes.

### SUMMARY

Although certain therapeutics are utilized as the standard of care to treat particular diseases (e.g., particular types of cancer), there is variation in the response of different individuals to the therapeutics. Tumor genetics contributes to tumor development and response to chemotherapy, but host germline genetic variation also can play an important role in variation in drug response. The present document is aimed at systematic, comprehensive pharmacogenomic studies to understand mechanisms by which genetic variation might contribute to sensitivity and/or resistance to therapeutic agents. These pharmacogenomic studies can utilize complementary pathway-based and genome-wide approaches to identify genes and polymorphisms associated with drug-response phenotypes. This information may ultimately make it possible to better individualize therapy. In addition, information regarding particular drugs may be extended to other therapeutic agents having similar structures or subject to similar metabolic pathways, for example. As an example, information regarding gemcitabine, a cytidine analog used to treat pancreatic adenocarcinoma, could potentially be extended to other agents, such as cytosine arabinoside (AraC), a cytidine analog used in the treatment of patients with acute myelogenous leukemia. In addition, information generated during such studies could be applied to other disorders that are treated with similar drugs.

This document is based, in part, on the discovery that cell lines can be used in pharmacogenomic studies aimed at individualizing treatment with particular therapeutic agents. For example, a panel of lymphoblastoid cell lines from various ethnic groups can be used to identify single nucleotide polymorphisms (SNPs) both on a genome-wide basis and in pharmacokinetic and pharmacodynamic pathways involved in metabolism of particular therapeutic agents. Certain SNPs then can be correlated with individual responsiveness to these therapeutic agents. The system described herein can be applied to virtually all drugs, with “layering” not only of the present suite of high throughput techniques, but any new techniques that might be developed (e.g., CpG methylation chips and copy number chips). Further, in addition to SNP data, proteomic, metabolomic, and/or transcriptomic data can be obtained from a panel of cell lines such as those described herein, and these data also can be correlated with individual responsiveness to therapeutic agents. In addition, a cell line panel as described herein can serve as an immortal and renewable source of data, in contrast to biological (e.g., blood) samples from patients who may not survive until future studies or who may even be deceased prior to the start of data collection.

This document also is based in part on the identification of two genes that can be used to predict effectiveness and cytotoxicity of AraC and gemcitabine on an individual basis. Gemcitabine and AraC GI₅₀ (concentrations required to inhibit growth by 50%) values were obtained by performing cytotoxicity assays using a lymphoblastoid cell line panel. Basal gene expression data also were obtained using the same set of cells. Correlation studies between basal gene expression and drug cytotoxicity identified genes associated with drug cytotoxicity. Based on p values and verification studies by quantitative RT-PCT (QRT-PCR), a series of functional analyses were performed for two selected candidate genes, FKBP5 and NT5C3, which validated the results from the genome-wide association study and indicated that at least these genes can be used to predict effectiveness and cytotoxicity of AraC and gemcitabine in individual subjects.

In one aspect, this document features a method for evaluating cellular response to a therapeutic agent, comprising: contacting the agent with a panel of cell lines from a plurality of individuals, the cell lines characterized for genetic variation in one or more genes encoding polypeptides within the biochemical pathway for metabolism of the agent; and correlating the response of the cell lines with the genetic variation. The panel can include cell lines from multiple ethnicities. For example, the panel can include at least 50 (e.g., at least 100) cell lines from Caucasian-American individuals, at least 50 (e.g., at least 100) cell lines from African-America individuals, and at least 50 (e.g., at least 100) cell lines from Han Chinese-American individuals.

The method can further comprise characterizing in the cell lines genetic variation in linkage disequilibrium with the genetic variation in one or more genes encoding polypeptides within the biochemical pathway of the agent. The cell lines can be characterized for genetic variation in at least 100 genes (e.g., at least 1,000 genes, or at least 10,000 genes). The cell lines can be further characterized for levels of one or more metabolites (e.g., at least 100 metabolites, at least 1,000 metabolites, or at least 10,000 metabolites). The cell lines can be further characterized for the levels of one or more polypeptides (e.g., at least 100 polypeptides, at least 1,000 polypeptides, or at least 10,000 polypeptides). The cell lines can be further characterized for the levels of one or more mRNAs (e.g., at least 100 mRNAs, at least 1,000 mRNAs, or at least 10,000 mRNAs). The agent can be any cytotoxic agent (e.g., a pyrimidine analog such as AraC or gemcitabine).

In another aspect, this document features a method for determining the likelihood of a subject to respond to AraC treatment, comprising: (a) comparing the level of NT5C3 expression in a biological sample from said subject to a control level of NT5C3 expression, and (b) classifying said subject as being likely to respond to AraC treatment if the level of NT5C3 expression is lower than said control level, or classifying said subject as not being likely to respond to AraC treatment if the level of NT5C3 expression is higher than said control level. The level of NT5C3 expression can be the level of mRNA expression or the level of NT5C3 protein. The subject can be a cancer patient (e.g., a subject diagnosed as having acute myelogenous leukemia).

In another aspect, this document features a method for determining the likelihood of a subject to respond to gemcitabine treatment, comprising: (a) comparing the level of NT5C3 expression in a biological sample from said subject to a control level of NT5C3 expression, and (b) classifying said subject as being likely to respond to gemcitabine treatment if the level of NT5C3 expression is lower than said control level, or classifying said subject as not being likely to respond to gemcitabine treatment if the level of NT5C3 expression is higher than said control level. The level of NT5C3 expression can be the level of mRNA expression, or the level of NT5C3 protein. The subject can be a cancer patient (e.g., a subject diagnosed as having a solid tumor).

In another aspect, this document features a method for determining the likelihood of a subject to respond to AraC treatment, comprising: (a) comparing the level of FKBP5 expression in a biological sample from said subject to a control level of FKBP5 expression, and (b) classifying said subject as being likely to respond to AraC treatment if the level of FKBP5 expression is higher than said control level, or classifying said subject as not being likely to respond to AraC treatment if the level of FKBP5 expression is lower than said control level. The level of FKBP5 expression can be the level of mRNA expression, or the level of FKBP5 protein. The subject can be a cancer patient (e.g., a subject diagnosed as having a acute myelogenous leukemia).

In still another aspect, this document features a method for determining the likelihood of a subject to respond to gemcitabine treatment, comprising: (a) comparing the level of FKBP5 expression in a biological sample from said subject to a control level of FKBP5 expression, and (b) classifying said subject as being likely to respond to gemcitabine treatment if the level of FKBP5 expression is higher than said control level, or classifying said subject as not being likely to respond to gemcitabine treatment if the level of FKBP5 expression is lower than said control level. The level of FKBP5 expression can be the level of mRNA expression, or the level of FKBP5 protein. The subject can be a cancer patient (e.g., a subject diagnosed as having a solid tumor).

Unless otherwise defined, all technical and scientific terms used herein have the same meaning as commonly understood by one of ordinary skill in the art to which this invention pertains. Although methods and materials similar or equivalent to those described herein can be used to practice the invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a diagram of the human variation cell line model system described herein.

FIG. 2 is a depiction of the structure of cytosine arabinoside (AraC).

FIG. 3 is a depiction of the AraC metabolic pathway.

FIG. 4 is a graph plotting survival of lymphoblastoid cell lines treated with varying concentrations of AraC.

FIG. 5 is a graph plotting AraC GI₅₀ in lymphoblastoid cell samples.

FIG. 6 is a schematic depicting the locations of polymorphisms in the nucleoside monophosphate and diphosphate kinase (CMPK) gene.

FIG. 7 is a graph plotting mRNA expression for genes in the AraC pathway in lymphoblastoid cells treated with AraC.

FIG. 8 is an HPLC chromatogram for AraCTP.

FIG. 9 is a depiction of the structure of gemcitabine.

FIG. 10 is a depiction of the gemcitabine metabolic pathway.

FIG. 11 is a schematic depicting the locations of polymorphisms in the ribonucleotide reductase regulatory subunit 2 (RRM2) gene.

FIG. 12 is a graph plotting the variation in expression of the ribonucleotide reductase regulatory subunit 1 (RRM1) gene in 203 lymphoblastoid cell lines.

FIG. 13 is a graph plotting survival of lymphoblastic cell lines treated with varying concentrations of gemcitabine.

FIG. 14 is a graph plotting GI₅₀ values for lymphoblastoid cells treated with gemcitabine.

FIG. 15 is a graph plotting the correlation of GI₅₀ values for gemcitabine treatment with expression of a 5′ nucleotidase.

FIG. 16 is an HPLC chromatogram for dFdCTP (GemTP), using AraATP as an internal control.

FIG. 17 is a pair of graphs plotting protein levels of CMPK and deoxycytidine kinase (DCK) as determined by Western blotting using extracts from COS-1 cells transfected with constructs containing nonsynonymous cSNPs.

FIG. 18A is a pair of graphs plotting the range of GI₅₀ values for the “Human Variation Panel” of 197 ethnically-defined lymphoblastoid cell lines. FIG. 18B is a series of graphs plotting the ranges of GI₅₀ values for AraC (left panels) and gemcitabine (right panels) after separating the samples based on gender (upper panels), storage time (middle panels), and race (lower panels).

FIG. 19 is a pair of graphs plotting genome-wide association between gene expression and correlation with sensitivity to gemcitabine (FIG. 19A) and AraC (FIG. 19B), with probes sets for genes on different chromosomes on the X axes and corresponding p values for each probe set on the Y axes.

FIG. 20A is a series of intersecting graphs showing the overlap of genes showing significant correlation between gemcitabine and AraC, using both Fastlo and GCRMA normalization. FIG. 20B is a graph plotting Pearson correlation values for 15 genes.

FIG. 21A is a graph plotting relative NT5C3 protein levels as determined in western blotting studies using SU86 pancreatic cancer cells (open columns) and MDA-MB-231 breast cancer cells (filled columns) that were treated or not treated with an siRNA targeted to NT5C3, as indicated. Error bars represent SEM values for 3 experiments. A picture of a representative blot is shown above the graph. FIG. 21B is a series of graphs plotting survival of SU86 cells (upper panels) and MDA-MB-231 cells (lower panels) treated with AraC (left panels) or gemcitabine (right panels) after first being treated or not treated, as indicated, with an siRNA targeted to NT5C3. Error bars represent SEM values for 3 independent experiments. FIG. 21C is a pair of graphs plotting the correlation between NT5C3 mRNA levels and intracellular levels of metabolites of AraC (left) and gemcitabine (right) in 14 lymphoblastoid cell lines for each drug selected to lie in the tails of adjusted GI₅₀ distributions. Rp and p-values for metabolites, with expression adjusted for GI₅₀, were RAraCDP=−0.50, pAraCDP=0.084; RAraCTP=−0.65, pAraCTP=0.016 RGemDP=−0.49, pGemDP=0.045; RGemTP=−0.52, pGemTP=0.033.

FIG. 22A is a graph plotting relative FKBP5 mRNA levels as determined by western blotting using SU86 pancreatic cancer cells (open columns) and MDA-MB-231 breast cancer cells (filled columns) that were treated or not treated with an siRNA targeted to NT5C3, as indicated. Error bars represent SEM values for 3 experiments. A picture of a representative western blot is shown above the graph. FIG. 22B is a series of graphs plotting survival of SU86 cells (upper panels) and MDA-MB-231 cells (lower panels) treated with AraC (left panels) or gemcitabine (right panels) after first being treated or not treated, as indicated, with an siRNA targeted to FKBP5. Error bars represent SEM values for 3 independent experiments.

FIG. 23 is a series of graphs plotting the correlation between relative caspase 3/7 activity and concentration of gemcitabine (FIGS. 23A and 23B) and AraC (FIGS. 23C and 23D) in MDA-MB-231 cells (FIGS. 23A and 23C) and SU86 cells (FIGS. 23B and 23D) that were treated or not treated, as indicated, with an siRNA targeted to FKBP5. Error bars represent SEM values for 3 independent experiments.

### DETAILED DESCRIPTION

### 1. Genotype-Phenotype Association Studies

This document relates to a “pharmacogenomic panel” of immortalized human lymphoblastoid cell lines obtained from healthy individuals of varying ethnicities that can be used for preclinical pharmacogenomic testing for common, functionally significant gene sequence variation that influences drug response phenotypes. Pharmaceutical companies could, for example, test drugs on this panel of cell lines prior to testing the drugs on patients. Medical researchers could use the cell line panel to determine genetic reasons for adverse drug reactions, or failure of a drug to be efficacious. A pharmacogenomic panel of cell lines can be used to test any type of therapeutic agent, including, without limitation, anti-cancer drugs (e.g., taxanes such as docetaxel and paclitaxel, cisplatin, anthrcyclines such as doxorubicin and epirubicin, and thiopurines such as 6-mercaptopurine and 6-thioguanine) and immunosuppressants (e.g., mycophenolic acid). A pharmacogenomic cell line panel also can be used to test drug metabolites such as N-acetyl-p-benzo-quinone imine (NAPQI), which is a toxic metabolite of acetaminophen. Further, such a panel can be used to test individual responses to radiation treatment, for example.

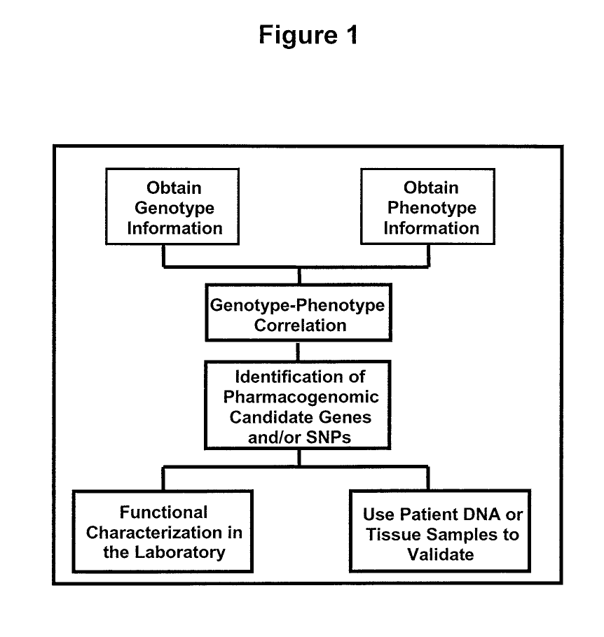

Drug response phenotypes can vary from life-threatening adverse drug reactions at one end of the spectrum to lack of the desired therapeutic efficacy at the other. Thus, the cell line panel described herein can be used to define, prior to patient drug exposure, the possible effect of common DNA sequence variation on drug response. For example, in depth resequencing data can be obtained in the cell lines for genes encoding proteins in known pathways for drug metabolism, drug transport, and drug effects. In addition, genome-wide single nucleotide polymorphisms (SNPs) across the entire genome can be obtained for the individual cell lines for use in genome-wide association studies. Genotype-phenotype correlation analyses using SNPs and intragene haplotype (the combination of SNPs on a given allele) resulting from gene resequencing and genome-wide SNPs can be performed to identify pharmacogenomic candidate genes, both within traditional pharmacokinetic (PK) and pharmacodynamic (PD) pathways, as well as across the entire genome. Expression array data for every gene in the human genome encoding a protein, as well as exon array data and genome-wide gene copy number information also can be obtained for the cell lines. Further, as future techniques for defining DNA sequence variation are developed, culminating in complete genomic sequence for each cell line, those techniques can be added to accumulate a dense array of information—in effect, a “data warehouse”—with respect to differences in DNA sequence and structure that can be correlated with variation in drug-related phenotypes. Those phenotypes may include variation in gene expression, variation in cytotoxicity, variation in apoptosis, variation in nucleic acid methylation, and variation in metabolites in response to varying concentrations of drug. All of this information can be used to perform both “pathway-based” and “genome-wide” genotype-phenotype correlations to identify genetic polymorphisms and/or haplotypes that can be used to develop hypotheses with the cell lines, which then can be tested functionally in the laboratory and also in the clinic, using patient DNA or tissue samples (see FIG. 1). Therefore, the panel of cell lines described herein can be used to identify and characterize the effect of common variation in DNA sequence and structure in human populations on drug response phenotypes that might be responsible for individual differences in adverse drug reactions or clinical drug efficacy. It is noted that in addition to sequence information, data related to levels of metabolites, polypeptides, and mRNAs can be obtained from the panel of cell lines and correlated to individual variation in drug effects.

Cells used in the model system described herein can be obtained commercially, for example, from the non-profit Coriell Institute for Medical Research (online at cimr.umdnj.edu). For example, the Human Variation Panel cell lines available from Coriell can be used. The Human Variation Panel includes immortalized lymphoblastoid cell lines collected from 100 African American (AA), 100 Caucasian American (CA), 100 Han-Chinese American (HCA) subjects and 23 CEPH (Utah family) cell lines. The panel used in the methods described herein can include any suitable number of individual cell lines from any ethnic group. For example, the panel can include from 50 to 100 individual AA cell lines, from 50 to 100 CA cell lines, and/or from 50 to 100 HCA cell lines. DNA from the cell lines can be used for in depth resequencing of genes of interest, and also to obtain genome-wide SNP data for use during genome-wide association studies. The advantage of this system is that the cells are “renewable” and broadly accessible to the general scientific community. In addition, these cell lines represent ethnically diverse population groups.

Modern genomic tools (e.g., genome-wide SNPs and in depth resequencing of functionally important genes) can be used with the cell line panel to identify genes that might be associated with drug response phenotypes. Phenotypes correlated with this genetic variation can include, for example, expression array and metabolomic data, drug-induced cytotoxicity, methylation status, copy number, and cell cycle effects. SNPs or genes showing significant association with these phenotypes then can be tested functionally and, eventually, clinically. In essence, each of the cell lines in the panel can be viewed as an individual “patient” with a unique genotype and a series of associated phenotypes that can be used for preclinical screening of pharmacogenomic candidate genes and SNPs. A tremendous advantage of this model system is the fact that high throughput genetic data for these cell lines can be added continuously. Therefore, unlike patient-based information, data for these cell lines can “accumulate” and be used for studies involving a variety of drug response phenotypes and a virtually endless series of drugs or drug candidates.

SNP and haplotype associations can be performed with cell-based phenotypes and/or with phenotypes related to the response to treatment of disease with particular therapeutics. Cell-based phenotypes include, for example, drug cytotoxicity, levels of intracellular drug metabolites, and gene expression before and after drug treatment in lymphoblastoid cells. Patient-related phenotypes include, for example, overall patient survival and/or time to progression after treatment, as well as drug-related toxicity phenotypes, including neutrophil and platelet counts.

The association of each SNP with the quantitative phenotypes of metabolite concentration, cytotoxicity (GI₅₀) and level of gene expression, as well as neutrophil and platelet counts can be evaluated with linear models in which genotypes for a SNP are evaluated with two indicators as covariates. This provides a 2 degree-of-freedom (df) test for each SNP. To assess single SNP genotype associations with patient survival time and time to progression, the Kaplan-Meier method can be used to estimate survival curves for the different genotypes. The curves can be compared using log-rank tests. Survival time as a function of genotype can be examined using the Cox proportional hazards model, and hazard ratios can be used to examine the survival rate by genotype (Cox (1972) Journal of the Royal Statistical Society Series B: 187-220). Disease status, age at time of treatment, gender and duration of treatment can be included as covariates in the proportional hazards models.

In addition to the association of phenotypes with SNPs, their association with intragene haplotypes can be evaluated for candidate genes using a global test of association. Since haplotypes are not observed directly, unknown phase can be accounted for using the score statistics developed by Schaid et al. ((2002) Am J Hum Genet 70:425-34). To estimate the magnitude of effects from haplotypes found to be significant using the score statistics, haplotype regression methods can be used. See, e.g., Lake et al. (2003) Hum Hered 55:56-65. Intragene haplotypes can be associated with gemcitabine clinical response using survival time and time to progression as phenotypes. All possible pairs of haplotypes can be evaluated for each patient, and the posterior probability can be associated with each haplotype using the EM algorithm, as implemented in the Splus library Haplostat (Schaid et al., supra). These posterior probabilities can be used to create expected design matrices to evaluate the association of haplotypes with survival time via the Cox model.

In addition to sequence information, data related to levels of one or more metabolites, polypeptides, and/or RNAs (e.g., mRNAs) can be obtained from cell lines and correlated to drug responses. Cell lines can be characterized for any number of SNPs, metabolites, polypeptides, and RNAs (e.g., at least 100, at least 1,000, at least 10,000, at least 20,000, at least 50,000, or at least 100,000 SNPs, metabolites, polypeptides, or RNAs). In some embodiments, a cell can be characterized for all SNPs, and levels of all metabolites, all polypeptides, and/or all mRNAs.

In some cases, information obtained for particular therapeutic agents can be extrapolated to other agents that have similar metabolic pathways. For example, data obtained for the pyrimidine analog gemcitabine, as described herein, can be extrapolated to other pyrimidine analogs such as AraC, 5-fluorouracil (5-FU), and the 5-FU prodrug, capecitabine. Further, information regarding the cellular response (e.g., apoptosis and metabolism) in various ethnic groups for various doses of particular agents can be obtained to determine whether higher or lower doses may be needed for efficacy, and whether particular ethnicities may respond adversely.

### 2. Cytosine Arabinoside and AML

Acute myelogenous leukemia (AML) is a rapidly fatal disease. Standard therapy consists of one or more cycles of induction therapy with AraC plus an anthracycline (Stone et al., “Acute myeloid leukemia,” in Hematology Am Soc Hematol Educ Program, 2004, pp. 98-117; Rowe and Tallman (1997) Blood 90:2121-2126; and Litzow (2000) Curr Treat Options Oncol 1:19-29), followed by multiple consolidation cycles that also include AraC (Mayer et al. (1994) N Engl J Med 331:896-903). The goal of the induction phase is to destroy hematopoietic elements in the bone marrow and to allow repopulation of the marrow with normal cells, resulting in complete remission (CR) (<5% marrow blasts) (Cheson et al. (2003) J Clin Oncol 21:4642-464). Although CR during initial induction can be achieved in 70-80% of the patients, 60-70% of patients relapse within 2 years, and the subsequent CR rate among those patients is only 30-50% (Stone et al., supra; and Estey and Dohner (2006)Lancet 368:1894-1907).

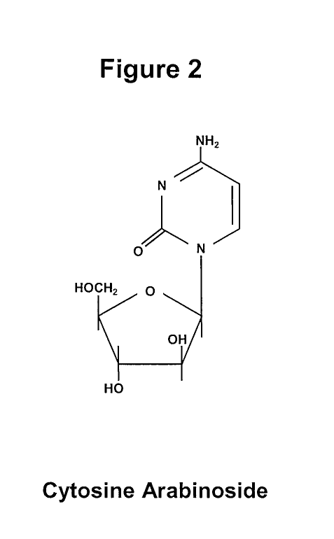

AraC is a cytidine analogue (FIG. 2) with activity against hematologic malignancies, especially AML (Rowe and Tallman, supra; and Galmarini et al. (2002) Br J Haematol 117:860-868). AraC must be transported into cells where it is metabolized to form an active phosphorylated metabolite, AraCTP (Plunkett et al. (1987) Semin Oncol 14(2 Suppl 1):159-166; and Ryan et al., “Cytidine analogues,” In: Cancer Chemotherapy & Biotherapy. Principles and Practice, Chabner and Longo, editors, 2006, Lippincott Williams & Wilkins: Philadelphia, pp. 183-211).

AraC cytotoxicity results from the blockade of DNA synthesis and triggering of DNA damage. AraC is transported into cells by two human equilibrative nucleoside transporters (SLC29A1 and 29A2) and three human concentrative nucleoside transporters (SLC28A1, A2 and A3) (Ryan et al., supra; Mackey et al. (1998) Cancer Res 58:4349-57; Gray et al. (2004) Pflugers Arch 447:728-34; King et al. (2006) Trends Pharmacol Sci 27:416-25; Ritzel et al. (2001) Mol Membr Biol 18:65-72; and Lostao et al. (2000) FEBS Lett 481:137-40). Once inside the cell, AraC can be inactivated by deamination catalyzed by cytidine deaminase (CDA) and deoxycytidylate deaminase (DCTD) (Peters et al. (1996) Semin Oncol 23:16-24; Goan et al. (1999) Cancer Res 59:4204-7; Heinemann et al. (1992) Cancer Res 52:533-9; and Heinemann et al. (1995) Semin Oncol 22:11-8). It can also be phosphorylated by DCK to form AraCMP (Veuger et al. (2002) Eur J Haematol 69:171-178) which is then phosphorylated by CMPK to form AraCDP and AraCTP. These phosphorylated metabolites, in turn, can be dephosphorylated by 5′-nucleotidases (5′-NTs) (Galmarini et al. (2005) Haematologica 90:1699-1701). Seven human 5′-NTs have been isolated and characterized. Five are cytosolic; one is located in the mitochondrial matrix; and one is present in the outer plasma membrane (Hunsucker et al. (2005) Pharmacol Ther 107:1-30; and Borowiec et al. (2006) Acta Biochim Pol 53:269-78). Substrate specificities have been clearly defined for only a few 5′-NTs (Oka et al. (1994) Biochem Biophys Res Commun 205:917-22; and Dumontet et al. (1999) Adv Exp Med Biol 457:571-7), but many of these enzymes could potentially be involved in AraC metabolism. AraC phosphorylation by DCK appears to be the rate-limiting step for further phosphorylation and is essential for the cytotoxic activity of the drug. Once AraCTP is formed, it competes with CTP for incorporation into DNA and inhibits DNA polymerase α (DNA pol α) (Ryan et al., supra; Momparler (1969) Biochem Biophys Res Commun 34:464-471; and Kufe et al. (1980) J Biol Chem 255:8997-8990). The inhibition also is dependent on dCTP concentrations (Kufe et al. (1984) Blood 64:54-58). dCTP can be synthesized directly by ribonucleotide reductase (RR) via the de novo pathway. RR consists of two subunits: subunit 1 (RRM1), and regulatory subunit 2 (RRM2) (Chabes and Thelander (2000) J Biol Chem 275:17747-53; Shao et al. (2005) Biochem Pharmacol 69:627-34; and Nordlund and Reichard (2006) Annu Rev Biochem 75:681-706). Recently, an additional subunit, p53R2 (RR2B), has been found to play an important role in supplying precursors for DNA repair in a p53-dependent process (Tanaka et al. (2000) Nature 404:42-9; and Eklund et al. (2001) Prog Biophys Mol Biol 77:177-268). Table 1 lists genes encoding proteins that are known to be involved in the “AraC pathway,” i.e., AraC transport, metabolism and activation.

AraC is part of all standard regimens for both the induction and consolidation therapy of AML, but there are large individual variations in response to therapy with AraC (Stone et al., supra). Therefore it would be useful to identify patients who might be resistant to or, conversely, might benefit optimally from AraC therapy.

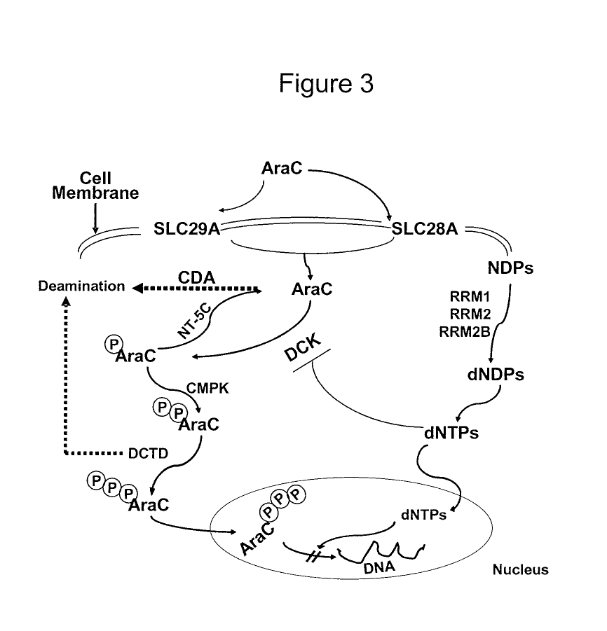

To move toward the goal of individualized therapy for AML, it is important to understand mechanisms responsible for AraC resistance and sensitivity. While the tumor genome plays a critical role in AML pathophysiology and response to therapy, host germline DNA genetic variation, including variation in genes encoding proteins involved in AraC transport and metabolism—the “AraC pathway” (FIG. 3)—as well as genes outside of that pathway, also may play important roles in variation in response to this drug (Fukunaga et al. (2004) Pharmacogenomics J 4:307-14).

The role of inheritance in individual variation in AraC response can be assessed using, for example, a panel of cell lines from various three ethnic groups to identify polymorphisms in genes in the AraC pathway (e.g., genes encoding proteins involved in AraC transport, metabolism, activation and targets), as well as genes outside of the pathway that are associated with AraC sensitivity and resistance. The results of such assessments can be tested by genotyping DNA from AML patients treated with AraC. For example, the 200-plus lymphoblastoid cell lines in the Human Variation Panel, which includes lines from three ethnic groups (Caucasian American, African American, and Han Chinese American), can be analyzed to produce in depth resequencing data for genes in the AraC pathway, as well as genome-wide single nucleotide polymorphisms (SNPs) for use in genome-wide association studies, and basal expression array data. The entire AraC pathway is expressed in these lymphoblastoid cell lines, although some of the transporters and several 5′-NTs are expressed at low levels (italicized in Table 1). Sequence variation in these genes can be examined, and genotypes and haplotypes can be correlated with a series of drug-response phenotypes in the model system, lymphoblastoid cells, and, using DNA from AML patients treated with AraC, with clinical response phenotypes. These cells then can be used to study AraC drug response phenotypes as a step toward defining genomic markers for the AraC response. Complementary studies of DNA samples from AML patients treated with AraC can then be used to test hypotheses developed using the cell line model system. Finally, cellular and genomic mechanisms responsible for these genotype-phenotype associations can be determined.

TABLE 1
Genes in the AraC and gemcitabine pathways

| HUGO | | Chromosome |
|---|---|---|
| name | Gene name | location |
| DCK | deoxycytidine kinase | 4q13.3-q21.1 |
| RRM1 | ribonucleotide reductase M1 polypeptide | 11p15.5 |
| RRM2 | ribonucleotide reductase M2 polypeptide | 2p25-p24 |
| RRM2B | ribonucleotide reductase M2B | 8q23.1 |
| | (TP53 inducible) | |
| CMPK | cytidylate kinase | 1p32 |
| CDA | cytidine deaminase | 1p36.2-p35 |
| DCTD | dCMP deaminase | 4q35.1 |
| SLC28A1 | Solute carrier family 28 member1 | 15q25-26 |
| SLC28A2 | Solute carrier family 28 member2 | 15q15 |
| SLC28A3 | Solute carrier family 28 member3 | 9q22.2 |
| SLC29A1 | Solute carrier family 29 member1 | 6p21.1-p21.2 |
| SLC29A2 | Solute carrier family 29 member2 | 11q13 |
| NT5C1A | 5′-nucleotidase, cytosolic IA | 1p34.3-p33 |
| NT5C1B | 5′-nucleotidase, cytosolic IB | 2p24.2 |
| NT5C2 | 5′-nucleotidase, cytosolic II | 10q24.32-q24.33 |
| NT5C3 | 5′-nucleotidase, cytosolic III | 7p14.3 |
| NT5C | 5′-nucleotidase, cytosolic | 17q25.1 |

### 3. Gemcitabine and Pancreatic Adenocarcinoma

Pancreatic cancer is a rapidly fatal disease with a 5-year survival rate of less than 5% (Jemal et al. (2005) CA Cancer J Clin 55:10-30; and Li et al. (2004) Lancet 363:1049-57). The poor prognosis for pancreatic cancer results from its metastasis-prone and therapy-resistant nature, which can be partially explained by genetic and epigenetic alterations within the tumor itself (El-Rayes and Philip (2003) Clin Adv Hematol Oncol 1:430-4; and Burris (2005) Semin Oncol 32:S1-3). However, host variation in germline DNA also may influence clinical response to gemcitabine therapy.

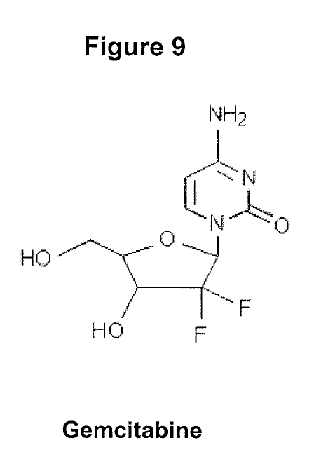

Gemcitabine (2′,2′-difluorodeoxycytidine, dFdc) is a cytidine analogue (FIG. 9) with activity against several solid tumors, including pancreatic ductal adenocarcinoma and non-small cell lung cancer (NSCLC) (Hertel et al. (1990) Cancer Res 50:4417-22; Berlin et al. (2002) J Clin Oncol 20:3270-5; Gridelli et al. (2003) J Natl Cancer Inst 95:362-72; and Schiller et al. (2002) N Engl J Med 346:92-8). Gemcitabine is a prodrug that is transported into cells where it undergoes a series of metabolic activation steps to form active phosphorylated metabolites, dFdCDP and dFdCTP (Peters et al. (1996) Semin Oncol 23:16-24; Goan et al. (1999) Cancer Res 59:4204-7; Heinemann et al. (1992) Cancer Res 52:533-9; and Heinemann et al. (1995) Semin Oncol 22:11-8).

There are large individual variations in response to therapy with gemcitabine (Burris et al. (1997) J Clin Oncol 15:2403-13; Neoptolemos et al. (2004) N Engl J Med 350:1200-10; Kindler (2005) Semin Oncol 32:S33-6; and Mini et al. (2006) Ann Oncol 17 Suppl 5:v7-v12). For example, the median survival for patients with pancreatic cancer treated with the drug is about 6 months, but approximately 20% of patients treated with gemcitabine have life expectancies of over one year. While tumor genome plays an important role in disease pathophysiology and response to treatment, variation in host germline DNA, including genes encoding transporters and enzymes involved in gemcitabine metabolism and activation, as well as targets for this drug, all representing steps in the gemcitabine pathway, as well as genes outside of the gemcitabine pathway, also may play an important role in variation in response to this drug (Fukunaga et al. (2004) Pharmacogenomics J 4:307-14).

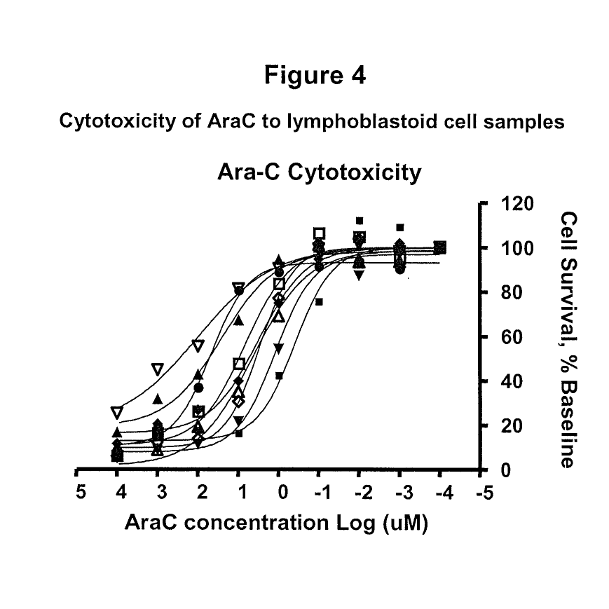

Gemcitabine has a complex metabolic pathway, and it ultimately results in cytotoxicity by blocking DNA synthesis and triggering DNA damage. The pathway for gemcitabine transport, activation, metabolism and effect is shown schematically in FIG. 4. Gemcitabine is inactivated by deamination catalyzed by cytidine deaminase (CDA) and deoxycytidylate deaminase (DCTD). It is transported into cells by nucleoside transporters. Gemcitabine is a substrate for two human equilibrative nucleoside transporter (hENT) family members (SLC29A1 and 29A2) and three human concentrative nucleoside transporters (hCNT) (SLC28A1, A2, and A3) (Baldwin et al. (2004) Pflugers Arch 447:735-43; Gray et al., supra; Mackey et al., supra; Ritzel et al., supra; and Lostao et al., supra). Gemcitabine also can be effluxed from cells by ATP-binding cassette (ABC) transporters, such as the multidrug resistance protein 1 (ABCC1) (Haimeur et al. (2004) Curr Drug Metab 5:21-53). Recently, ABCC5, which lacks the transmembrane domain that is present in ABCC1, was shown to confer resistance to gemcitabine (Oguri et al. (2006) Mol Cancer Ther 5:1800-6). Once gemcitabine is inside of the cell, it is phosphorylated by DCK to form a monophosphorylated metabolite, difluorodeoxycytidine monophosphate (dFdCMP) (Heinemann et al. (1988) Cancer Res 48:4024-31). This metabolite is subsequently phosphorylated by CMPK to form dFdCDP and dFdCTP. These phosphorylated forms, in turn, can be dephosphorylated by 5′-nucleotidases (5′-NT). Seven human 5′-nucleotidases have been characterized, with 5 located in the cytosol (Hunsucker et al., supra; and Borowiec et al., supra). The substrate specificities have been defined for only a few of these 5′-NTs (Oka et al., supra; and Dumontet et al., supra). Among the five cytosolic 5′-NTs, 5′-NT IA (NT5C1A) has the highest affinity for deoxynucleotide monophosphates. Overexpression of NT5C1A in HEK293 cells resulted in gemcitabine resistance, suggesting that dFdCMP is a substrate for NT5C1A (Hunsucker et al. (2001) J Biol Chem 276:10498-504). Although the kinetic properties of human cytosolic 5′-NT II (NT5C2) makes it less likely that to contribute to pyrimidine dephosphorylation, dFdC-resistant K562 cells have increased cytosolic 5′-NT II. The role of the pyrimidine-specific nucleotidase 5′-NT III (NT5C3) in gemcitabine phosphate hydrolysis remains unclear. The cytosolic 5′(3′)-deoxyribonucleotidase (NT5C) is also a good candidate for mediating nucleoside analogue resistance as a result of its preference for deoxyribonucleoside monophosphates (Rampazzo et al. (2000) Proc Natl Acad Sci USA 97:8239-44; and Rampazzo et al. (2000) J Biol Chem 275:5409-15). As a result of the limited information with regard to this family, several 5′-NTs could potentially be involved in gemcitabine metabolism.

Gemcitabine also can be phosphorylated by thymidine kinase 2 (TK2) (Wang et al. (1999) FEBS Lett 443:170-4). However, this enzyme phosphorylates gemcitabine only 5-10% as well as deoxycytidine (DCK). As a result, DCK catalyzed phosphorylation of gemcitabine appears to be the rate-limiting step for the formation of active metabolites and is essential for the cytotoxic activity of the drug. Once dFdCDP is formed, it inhibits ribonucleotide reductases (RRM1, RRM2 and RRM2B), enzymes that catalyze reactions which generate the dTPs required for DNA synthesis. Therefore, RR inhibition causes a decrease in dCTP pools and decreased feedback inhibition of DCK, leading to an increase in gemcitabine phosphorylation to form dFdCTP (Heinemann et al. (19990) Mol Pharmacol 38:567-72; Baker et al. (1991) J Med Chem 34:1879-84; Schy et al. (1993) Cancer Res 53:4582-7; Gandhi et al. (1996) Cancer Res 56:4453-9; and Ruiz van Haperen et al. (1994) Biochem Pharmacol 48:1327-39). RR consists of two subunits, subunit 1 (RRM1) and a regulatory subunit, RR subunit 2 (RRM2) (Nordlund and Reichard (2006) Annu Rev Biochem 75:681-706). Catalytic activity is dependent on both RRM1 and RRM2 (Nordlund and Reichard, supra; Chabes and Thelander (2000) J Biol Chem 275:17747-53; and Shao et al. (2005) Biochem Pharmacol 69:627-34). Another subunit, p53R2 (RR2B), has been found to play an important role in supplying precursors for DNA repair in a p53-dependent process (Tanaka et al. (2000) Nature 404:42-9; and Eklund et al. (2001) Prog Biophys Mol Biol 77:177-268). Since p53 is mutated in 50% of tumors and since p53R2 forms heterodimers with RRM1, although activity of the heterodimer is about 20-50% lower than that of RRM2-containing RR (Qiu et al. (2006) Biochem Biophys Res Commun 340:428-34; and Xue et al. (2003) Cancer Res 63:980-6), genetic variation in any of these 3 subunits could potentially influence response to gemcitabine. Therefore, it is important that all 3 subunits are taken into account in the proposed study. Increased intracellular concentrations of dFdCTP also can inhibit dCMP deaminase (DCTD) and decrease the catabolism of dFdCMP, allowing the self-potentiation of dFdC cytotoxicity. In addition, the deamination product of dFdCMP, dFdUMP can inhibit thymidylate synthase (TS). Inhibition of thymidylate synthase activity is associated with an increase in DNA synthesis errors, leading to DNA damage (Bergman et al. (2000) Eur J Cancer 36:1974-83; and Ruiz van Haperen et al. (1995) Semin Oncol 22:35-41).

In summary, gemcitabine cytotoxicity results from a combination of the actions of dFdCDP and dFdCTP. dFdCDP inhibits RR, while dFdCTP competes with dCTP for incorporation into DNA and inhibits the exonuclease activity of DNA polymerases ε (POLE), causing DNA synthesis termination and DNA damage. Table 1 lists genes encoding proteins that are known to be involved in the gemcitabine pathway, i.e., gemcitabine transport, metabolism, and targets. The entire gemcitabine pathway is expressed in the lymphoblastoid cells, although some of the transporters and several 5′-NTs, 5NTC1A and 5NTC1B, are expressed at very low levels (italicized in Table 1). Genetic variation in these genes can be studied, and genotypes and haplotypes can be correlated with a series of drug-response related phenotypes, including gemcitabine cytotoxicity and intracellular gemcitabine metabolite levels in the model system, lymphoblastoid cells, and by using DNA from patients with pancreatic carcinoma treated with gemcitabine, with clinical response as a phenotype. This pathway-based approach can be complemented by genome-wide association studies performed with lymphoblastoid cells.

The role of inheritance in the individual response to gemcitabine can be studied using, for example, a panel of cell lines from various ethnic groups. Using such a panel, polymorphisms can be identified in genes in the gemcitabine pathway, as well as genes outside of that pathway, that are associated with gemcitabine sensitivity and resistance. Such studies can utilize, for example, the Human Variation Panel of lymphoblastoid cell lines from over 200 people of three ethic groups (Caucasian American, African American, and Han Chinese American). The inventors have used this panel to generate in depth resequencing data for genes encoding proteins involved in gemcitabine transport, metabolism, activation and targets (the “gemcitabine pathway”), genome-wide single nucleotide polymorphisms (SNPs) for use in genome-wide association studies, and basal expression array data. These cells also can be used to determine gemcitabine drug response phenotypes as a step toward defining genomic markers for gemcitabine response. Complementary studies of DNA samples from pancreatic patients treated with gemcitabine then can be used to test hypotheses developed with the cell line model system. In addition, cellular and genomic mechanisms responsible for these genotype-phenotype associations will be determined. Given the poor prognosis of pancreatic cancer patients, survival time and time to progression can be used as endpoints for the drug response. In addition, since the most common side effects related to gemcitabine treatment of pancreatic cancer are neutropenia and thrombocytopenia, neutrophil and platelet counts can be used as indicators of gemcitabine-related toxicity.

### 4. Methods

This document provides methods for determining the likelihood that a subject (e.g., a cancer patient) will respond to therapy with a cytidine analogue such as AraC or gemcitabine. The methods can include, for example, measuring the expression level for one or more genes in a biological sample from a subject, comparing the expression level to a standard level of expression for the gene, and/or classifying the subject as being likely or not likely to respond to therapy with the cytidine analogue based on the comparison. For example, if the level of NT5C3 expression in a subject is lower than a control level, the subject can be classified as being more sensitive to the drug, and thus more likely to respond to treatment. Conversely, if the level of NT5C3 expression in a subject is higher than a control level, the subject can be classified as being less sensitive to the cytidine analogue, and less likely to respond to treatment. As another example, if the level of FKBP5 expression in a subject is higher than a control level, the subject can be classified as being more sensitive to the drug, and thus more likely to respond to treatment. Conversely, if the level of FKBP5 expression in a subject is lower than a control level, the subject can be classified as being less sensitive to the drug, and less likely to respond to treatment.

Suitable subjects include, without limitation, mammals, including, for example, humans, non-human primates such as monkeys, baboons, or chimpanzees, horses, cows (or oxen or bulls), pigs, sheep, goats, cats, rabbits, guinea pigs, hamsters, rats, gerbils, and mice. A “biological sample” is a sample that contains cells or cellular material. Suitable biological samples include, for example, blood, urine, cerebrospinal fluid, pleural fluid, sputum, peritoneal fluid, bladder washings, oral washings, tissue samples (e.g., tumor samples), touch preps, or fine-needle aspirates.

The level of gene expression can be determined using any suitable method, including those well known in the art. For example, the level of gene expression can be based on mRNA levels, as determined by Northern blotting or RT-PCR, for example. The level of gene expression also can be determined based on polypeptide levels, as determined by western blotting, for example. A control level of expression for a particular gene can be, for example, an average level determined based on expression levels in a plurality of individuals, a level of gene expression in a sample from a normal individual, expression in a sample from the subject known not be cancerous (e.g., a contralateral kidney or lung, normal tissue surrounding or adjacent to a tumor, or an uninvolved lymph node).

The invention will be further described in the following examples, which do not limit the scope of the invention described in the claims.

### EXAMPLES

### Example 1

### AraC Experiments

### Genotype-Phenotype Association Studies with AraC-Response Phenotypes Using Coriell Lymphoblastoid Cell Lines

Cell lines were obtained from the Coriell Institute for 60 Caucasian-American (CA), 60 African-American (AA), 60 Han Chinese-American (HCA), and 23 CEPH(CA) subjects. These cell lines were used to obtain in depth resequencing data for most genes in the AraC pathway, genome-wide SNPs assayed with the Illumina HumanHap 550 and 650 K BeadChips and basal expression array data.

Basal expression analyses were performed for all 203 cell lines. Repeat expression array analyses also are performed after AraC treatment using Affymetrix U133 Plus 2.0 GeneChips with “resistant” and “sensitive” cell lines selected on the basis of IC₅₀ values determined during the cytotoxicity studies. Both sets of expression data are used as phenotypes.

The inventors have identified common sequence variation in genes involved in the AraC transport, metabolism and activation pathway, and genome-wide SNP data is being obtained using Illumina HumanHap 550 and 650 K BeadChips. Specifically, most of the genes in the AraC pathway (FIG. 3 and Table 1) have been resequenced, and more than half of the SNPs identified are not present in public databases. In addition, 71 of these 203 cell lines have been genotyped for 1.5 million genome-wide SNPs (Hinds et al. (2005) Science 307:1072-9). Genome-wide SNP analyses is being performed for all of the cell lines using Illumina HumanHap BeadChips. Basal gene expression levels in these cell lines has been determined as a phenotype that can be correlated with genotype and/or with drug response phenotypes. The expression array studies were performed using Affymetrix U133 Plus 2.0 GeneChips. Most genes displayed at least 2 to 3-fold variations in expression, including the AraC pathway genes DCTD, CMPK and DCK. These expression data are one of the phenotypes to be correlated with genotype.

Cytotoxicity, intracellular AraC metabolite levels, and expression array data after drug exposure also are used as phenotypes to perform both pathway-based and genome-wide genotype-phenotype correlation analyses. In addition, AraC intracellular metabolites (parent drug and AraCTP) are assayed with an HPLC assay after drug exposure in these same lymphoblastoid cell lines.

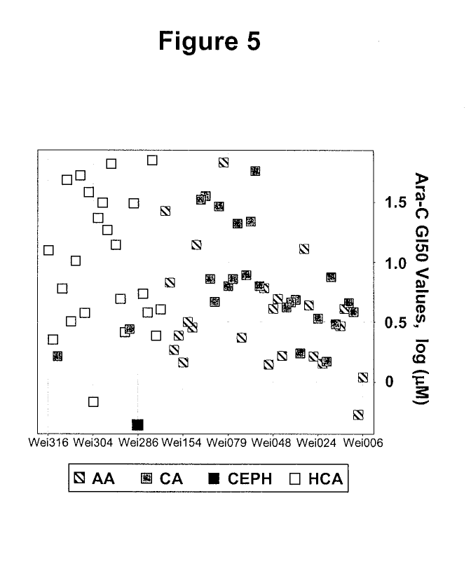

Preliminary AraC cytotoxicity studies were conducted with the 71 lymphoblastoid cell lines for which genome-wide SNP data was obtained. Cytotoxicity was assayed using an MTS assay, with AraC concentrations from 0.0001 to 100 μM. All studies were performed in triplicate, and IC₅₀ (GI₅₀) and LC₅₀ values were calculated using a four parameter logistic model. An example of AraC cytotoxicity data for individual cell lines is shown in FIG. 4, with each symbol representing an individual cell line. Variation in IC50 values (the drug concentration that inhibited cell growth 50%) for the initial 71 cell lines studied are shown in FIG. 5, in which the colors represent different ethnic groups. The AraC IC₅₀ data for these 71 cell lines also have been used to perform preliminary association studies between phenotypes such as mRNA expression level and genotypes for genes in the AraC pathway. Significant associations were observed for several of those genes. Biological replicates of the cytotoxicity studies are performed to determine the reproducibility of this drug response phenotype.

### Genotype-Phenotype Association Using DNA from AML Patients Treated with AraC

Haplotype tag SNPs (htSNPs) and linkage disequilibrium SNPs (LD SNPs) are selected on the basis of the resequencing data for genes in the AraC pathway, as well as genes outside of the AraC pathway selected on the basis of the results of genome-wide association studies performed with the cell lines. DNA samples from patients with AML who were treated with AraC are genotyped using these htSNPs and LD SNPs, as well as any SNPs showing significant associations with phenotype, i.e., both pathway-based and genome-wide analyses. The phenotypes analyzed include—but are not limited to—the occurrence of complete remission (CR) (<5% marrow blasts), time to relapse after remission and overall survival from time of diagnosis. The occurrence of drug-related side effects as well as duration of decreased neutrophil and platelet counts are used as indicators of AraC-related toxicity.

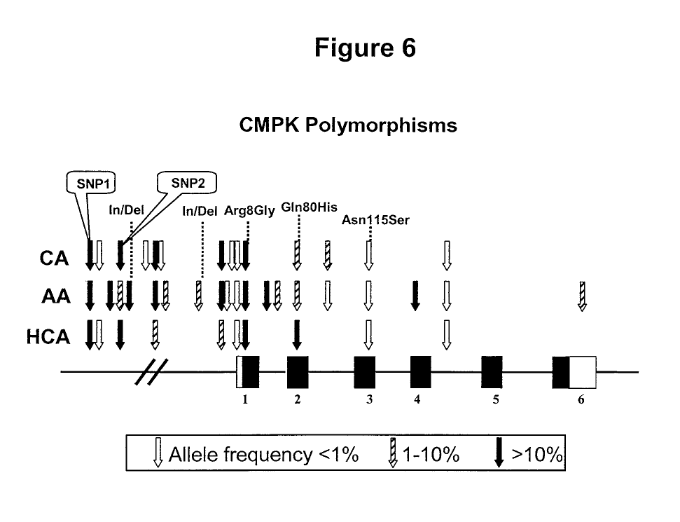

Since basal level of gene expression could be related to AraC metabolism and effect, preliminary genotype-phenotype correlation studies were performed with several “AraC pathway” genes for the initial 71 cell lines studied. All data were corrected for gender, ethnicity and subject age. In each case, several SNPs were identified that were significantly associated with level of gene expression in these cells. For example, when the AraC kinase gene CMPK was analyzed, two SNPs in a region 3000 by upstream from the ATG translation initiation codon (highlighted with pink and green boxes in FIG. 6) showed a significant correlation with CMPK expression in all three ethnic groups, even after correcting for multiple comparisons. FIG. 6 also shows all of the SNPs identified during the CMPK gene resequencing studies as an example of the in depth resequencing data generated for all of these genes. Neither of the two SNPs highlighted in FIG. 6 are present in public databases, and neither has been studied previously. To determine whether these SNPs might alter sequences that bind transcription factors, experiments such as luciferase reporter gene studies and gel shift assays are performed using probes containing the SNPs.

Preliminary genome-wide association studies also have been performed, using the 1.5 million genome-wide SNPs and AraC cytotoxicity data (IC₅₀, IC₂₅ and IC₇₅ values) for the 71 cell lines for which Perlegen SNPs are publicly available (Davidson et al. (2004) Cancer Res 64:3761-6)). As a first step, the Perlegen SNPs were “validated.” Attention was then focused on SNPs with P values<10⁻⁶ for association with cytotoxicity because of the issue of multiple comparisons. Among those SNPs, 18 were observed that mapped to chromosomes 1, 5, 9, 15 and 18. This type of analysis can result in identification of “non-pathway” genes that contribute to AraC sensitivity and resistance. Once they are identified, those genes are tested by performing overexpression or siRNA studies to determine possible mechanistic explanations for their association with cytotoxicity. In addition, genes identified in this way are resequenced to supply more complete data with regard to gene sequence variation for use in functional genomic testing.

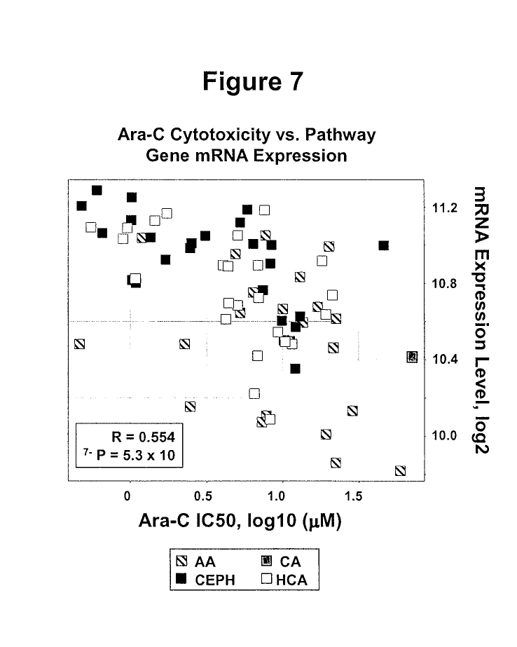

Previous studies have shown that the expression of genes involved in AraC transport, metabolism, and activation can be associated with AraC sensitivity and resistance in tumor tissue or tumor cell lines. Therefore, the possible association between pathway gene expression and cytotoxicity was tested in the initial 71 cell lines studied, even though they represented an ethnically mixed group. During the preliminary analysis, several genes showed significant correlation between expression and AraC cytotoxicity, including several 5′-NTs and one deaminase gene. The correlation between IC₅₀ values and expression for one of the 5′-NTs is depicted graphically in FIG. 7. Expression levels were Log₂ transformed, and IC₅₀ values were Log₁₀ transformed.

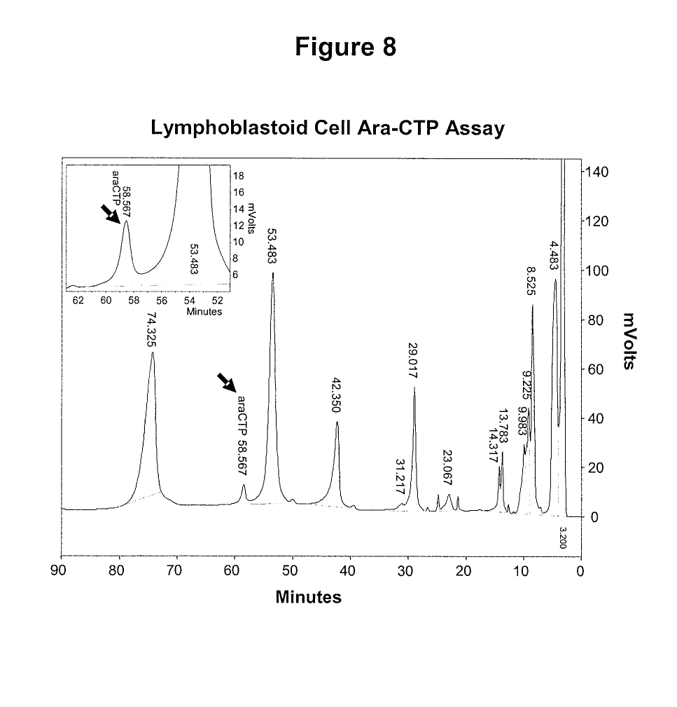

The AraC intracellular metabolite, AraCTP, has been associated with drug sensitivity in tumor cell lines. However, there is very little information with regard to the relationship between gene sequence variation and intracellular metabolite concentrations. Because of its reported relationship to AraC cytotoxicity, AraCTP concentrations are measured in the cell lines using an HPLC assay developed to measure intracellular metabolites (FIG. 8). This phenotype will be associated with genotype for each gene in the AraC pathway and will also be used to perform genome-wide association studies.

### Functional and Mechanistic Characterization of SNPS in “AraC Pathway” Genes Associated with Phenotypes

Expression constructs containing nonsynonymous cSNPs are generated and are then expressed in mammalian cell lines to study the effect of the cSNPs on function. Reporter gene constructs containing common 5′-FR haplotypes are created, and luciferase activity is assayed in selected cell lines. Electrophoresis mobility shift (EMS) assays also are performed, as well as searches of transcription factor binding motif databases to help identify transcription factor binding motifs altered by the SNPs. Minigene constructs that contain the SNPs of interest are created, and RT-PCR is performed to assess the possible effect of the SNPs on RNA splicing patterns and mRNA stability.

Functional studies also are conducted for SNPs in 5′-FRs and 3′-UTRs, as well as SNPs in intron-exon splice junctions in genes involved in the AraC pathway that are associated with any of the phenotypes studied.

### Examination of Patient DNA Samples

DNA samples from patients with AML are obtained from the Adult Leukemia Program of the Sidney Kimmel Comprehensive Cancer Center at Johns Hopkins, and the Division of Developmental Oncology Research, Mayo Comprehensive Cancer Center. Virtually all newly diagnosed patients at both centers receive AraC-based induction therapy. For example, the Johns Hopkins group collects cellular and serum samples from approximately 100-120 newly diagnosed and 50-60 patients with relapsed or refractory disease annually. DNA samples were previously collected from 700 individual AML patients treated uniformly with induction therapy that consisted of AraC, daunorubicin and etoposide. These patients were nearly all Caucasian, and approximately 80% are now deceased. DNA is extracted from all of these samples. These AML patient DNA samples are then genotyped to test genetic hypotheses with respect to AraC pharmacogenomics, generated using the lymphoblastoid cell line model system.

### Expression Array Studies with Cells Treated with AraC

Basal Affymetrix U133 Plus 2.0 GeneChip expression array analyses have been performed with all 203 lymphoblastoid cell lines. AraC cytotoxicity studies also are performed with all of these cell lines. Since the purpose of the study is to understand the potential contribution of inheritance to variation in AraC sensitivity and resistance, experiments are conducted to determine whether genetic variation might alter gene expression after AraC treatment. Post-drug exposure expression array studies are performed on selected “resistant” and “sensitive” cell lines based on the criteria developed by NCI for the “NCI-60” cell lines. This approach makes it possible to obtain information with regard to differences between sensitive and resistant cell lines in gene expression patterns, as well as differences in gene expression levels in individual cell lines under basal conditions and after drug exposure. These expression array studies, like the basal analyses, are performed with Affymetrix U133 Plus 2.0 GeneChips. This phenotype, together with basal expression array data, cytotoxicity data and drug metabolite data, are used to perform genotype-phenotype correlation analyses with genes in the AraC pathway (FIG. 3) and to perform genome-wide association studies.

### Genotyping DNA Samples from AML Patients Treated with AraC

ht and LD SNPs are selected for use in genotyping the patient DNA samples based on the gene resequencing data. The algorithm for choosing htSNPs involves: 1) estimating haplotype frequencies using the EM algorithm; 2) choosing haplotypes to tag; and 3) evaluating all possible subsets of SNPs, and for each subset determining how well it explains variation for each of the targeted haplotypes. Because rare haplotypes require extremely large sample sizes for association studies, only tag haplotypes with frequencies of at least 5% are tagged. Although the htSNP method reduces the number of SNPs required to accurately tag haplotypes, it may not necessarily capture long-range LD as efficiently as pair-wise measures of LD, so the LD-Select method also will be applied (available online at droog.gs.washington.edu/ldSelect.html. The SNPs used to genotype patient DNA samples are tagged SNPs selected on the basis of the resequencing studies of genes in the AraC pathway, SNPs selected using the HapMap Resource, or SNPs showing significant association with phenotypes during genotype-phenotype association studies performed with the lymphoblastoid cell lines. Nonsynonymous cSNPs and SNPs associated with functional effects during the functional genomic studies also are included. Genotyping will be performed using the Illumina GoldenGate™ Platform to genotype approximately 700 patient DNA samples. For functionally significant variable number of tandem repeats (VNTRs) as well as other “length” polymorphisms, the “GenScan” system that utilizes an ABI DNA sequencer and fluorescence-labeled primers will be used to determine amplicon length.

DNA samples obtained from patients with AML who were treated with a single AraC-containing regimen are genotyped for tag SNPs as well as any SNPs found to be associated with AraC response phenotypes during the cell-based experiments. Phenotypes analyzed during the clinical association studies include overall survival, the occurrence of and time to CR, as well as time to relapse for patients during initial induction therapy. Association studies also are performed with AraC toxicity-related phenotypes such as myelosuppression and the occurrence of a variety of side effects ranging from cerebellar symptoms to diarrhea and respiratory distress syndrome.

### Genotype-Phenotype Association Studies

Patient-related phenotypes include the induction of complete remission (CR) (marrow blasts <5%), time to achievement of CR, time to relapse after AraC induction therapy, overall survival from the time of diagnosis and AraC-related toxicity phenotypes, including the occurrence of cerebellar toxicity, diarrhea, adult respiratory distress syndrome, hyperbilirubinemia and duration of neutropenia and thrombocytopenia. The association of each SNP with quantitative phenotypes such as metabolite concentrations, cytotoxicity (IC₅₀) and level of gene expression for the cell lines, as well as duration of depressed neutrophil and platelet counts in the patients, are evaluated with linear models in which genotypes for a SNP are evaluated with two indicators as covariates. Covariates of gender and race also are included in the linear model. In addition to these phenotypes for the 203 cell lines and the 700 AML patients, assess genotype-phenotype correlations also are assessed using post AraC drug exposure expression array data collected from the sensitive and resistant cell lines. In addition to these analyses, the association of each SNP with the qualitative phenotype of complete remission (CR) or lack of CR in the 700 AML patients is assessed with logistic regression models together with the assessment of the association of genotype with patient survival time and length of CR. Assessment of time of event endpoints (survival time, time to complete remission) is performed using the Kaplan-Meier method to estimate survival curves for different genotypes. These curves are compared using log-rank tests. Survival time as a function of genotype is examined using the Cox proportional hazards model, and hazard ratios are used to examine survival rate by genotype. This analysis is stratified based on age at diagnosis, karyotype (good risk, intermediate risk or poor risk), history of previous hematological malignancy, history of previous chemotherapy, and WBC count at diagnosis. Disease status, progression, age, race, gender and duration of treatment will be included as covariates in the proportional hazards model. In addition to the association of phenotypes with SNPs, the association of phenotypes with intragene haplotypes also is evaluated for candidate genes using a global test of association. Rather than apply a conservative Bonferonni correction, permutation tests are used to empirically determine the appropriate p-value to determine significance, while correcting for the evaluation of multiple SNPs and haplotypes.

Power calculations are performed to estimate the minimum detectable R² for associations between the quantitative phenotypes of cytotoxicity and metabolite levels and the genetic effect of a causative locus based on the analysis of a SNP (assuming the SNP is in high LD with the causative locus). The calculations assumed a sample size of 203 cell lines, minor allele frequency of 0.05, additive genetic model, and a stringent alpha level of 0.001. After standardizing the phenotypes, we would have 80% and 90% power to detect a minimum R² of 8.0% and 10%, respectively. Based on our past analyses, we have found that only a few haplotypes are common, and no more than 20 haplotypes are expected to have frequencies greater than 1%. Therefore, we use 20 as a conservative estimate of the number of regression coefficients and a significance level of 0.05, 0.01 and 0.003 (Bonferroni correction for 15 haplotype tests for 15 genes). For the 203 Coriell cell lines, we will have 80% power to detect a minimum R² of 10%-15.5% and 90% power to detect a minimum R² of 12.5%-17.5% when the significance level ranges from 0.05 to 0.003, respectively.

Power calculations for 700 patient DNA samples for the quantitative phenotypes of neutropenia and thrombocytopenia were performed to estimate the minimum detectable R² values for associations between these phenotypes and single SNP genetic effect. These calculations assumed a sample size of 700 patients, 80% or 90% power, minor allele frequency of 0.05, additive genetic model, and a stringent alpha level of 0.001 to adjust for some of the multiple testing issues. After standardizing the phenotypes, one would have 80% and 90% power to detect a minimum R² of 2.5% and 3.0%, respectively. The power for the haplotype analysis using these quantitative traits was computed in the same manner as for the cell lines, using the non-central F distribution. One would have 80% and 90% power to detect a minimum R² of 5.2% and 6.1% with a stringent significance level of 0.001, respectively. Power to estimate the minimum detectable odds ratio for genetic association with the occurrence of CR was calculated assuming 70% of the 700 AML patients would achieve CR and 30% would not achieve CR. One would have 80% power to detect an odds ratio of 2.9 with a significance level of 0.01. For survival analyses for the 700 AML DNA patients, power to detect the genetic effect of a causative locus based on the analysis of a single nucleotide polymorphism was computed for a dominant genetic model in which the median survival of patients homozygous or heterozygous for the rare allele was compared to the median survival of patients homozygous for the common allele. To have 80% power and a type 1 error of 5%, with 700 patients, one would have adequate power to detect a 35% difference in median survival time with a minor allele frequency of 10% or greater and a 50% difference in median survival with a minor allele frequency of 5% or greater. With a type 1 error of 1%, one would have adequate power to detect a 50% difference in median survival with a minor allele frequency of 10% or greater.

### Example 2

### Gemcitabine Experiments

### Genotype-Phenotype Association Studies with Gemcitabine-Response Phenotypes Using Coriell Lymphoblastoid Cell Lines

Cell lines were obtained from the Coriell Institute for 60 Caucasian-American (CA), 60 African-American (AA), 60 Han Chinese-American (HCA) and 23 CEPH(CA) subjects. The inventors have obtained in depth resequencing data for most genes in the gemcitabine pathway, genome-wide SNPs assayed with the Illumina HumanHap 550 K BeadChips, and basal expression array data from these cells.

Resequencing: Resequencing was performed using dye terminator cycle sequencing to sequence PCR amplification products. The resequencing studies have involved all exons and splice junctions in each gene, as well as approximately 2 kb of 5′-FR, plus areas of greater than 70% cross-species sequence homology within introns or further upstream in the 5′-FR. Additional regions also are resequenced for the proposed genotype-phenotype association studies to identify SNPs in linkage disequilibrium with SNPs that show association with phenotypes. Most genes in the gemcitabine pathway have been resequenced, as described below. In addition, genome-wide SNP analyses are performed with DNA from all 203 of the Coriell cell lines, using Illumina HumanHap 550K BeadChips.

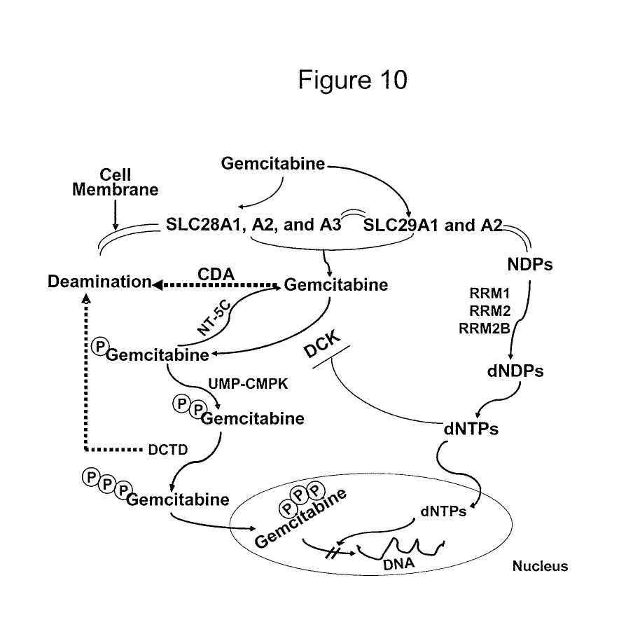

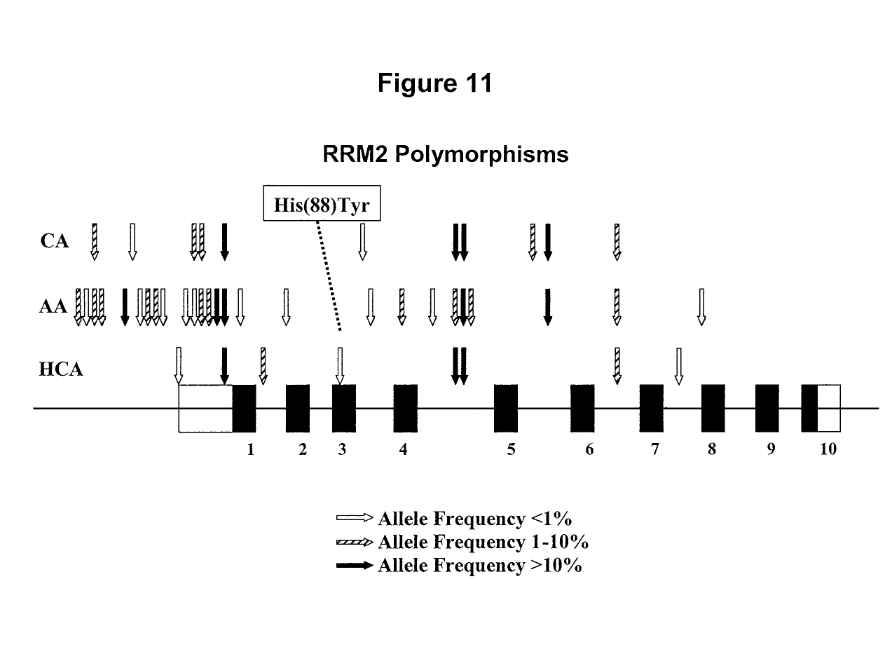

Most of the genes in the gemcitabine pathway (Table 1 and FIG. 10) have been resequenced. FIG. 11 shows an example of the SNPs identified in the RRM2 gene. The black boxes represent coding regions and open boxes represent untranslated regions of exons. Arrows represent individual SNPs, with colors showing different allele frequencies. A nonsynonymous cSNP that altered the encoded amino acid is boxed. The majority of SNPs identified through the gene resequencing effort are not publicly available. For example, more than half of the SNPs identified in genes such as CMPK, CDK and RRM2 (Table 2) during the gene resequencing studies were not in public databases. Therefore, the in depth resequencing effort adds power to select tag SNPs for use in genotype-phenotype association studies. In addition, 71 of the 203 cell lines to be studied have been genotyped by Perlegen for 1.5 million genome-wide SNPs (Hinds et al. (2005) Science 307:1072-9). As mentioned herein, genome-wide SNP analysis is performed using Illumina HumanHap 550K BeadChips for all of the cell lines.

TABLE 2
SNPs identified during resequencing

| | SNPs identified through | SNPs in the |
|---|---|---|
| HUGO name | resequencing | database |
| DCK | 25 | 10 |
| CMPK | 28 | 6 |
| RRM2 | 35 | 3 |

Genotype-phenotype correlation studies were performed with several “pathway” genes in these 203 cell lines. The data were corrected for gender, ethnicity, and age. Included among the genes analyzed were CMPK, DCK and RRM2. For example, when CMPK was analyzed, two SNPs in a region located 3000 by upstream of the ATG translation initiation codon showed a significant correlation with CMPK expression in all three ethnic groups, even after correcting for multiple comparisons. FIG. 6 shows the results obtained by resequencing CMPK as shown for the RRM2 gene in FIG. 11. The two polymorphisms that were related to expression are highlighted with pink and green boxes. Neither SNP is found in public databases, and neither has been studied previously. Luciferase reporter gene constructs containing these two SNPs are prepared, and gel shift assays are performed with probes containing the SNPs to determine whether they might disrupt sequences that bind transcription factors and, thus, alter transcription. In addition to basal expression level, SNP association studies with the other phenotypes described herein are performed. Since these SNPs will often be in linkage disequilibrium with other polymorphisms, intragene haplotype analyses also are conducted with all the phenotypes, using data generated by the inventors as well as HapMap data.

Hardy-Weinberg equilibrium (HWE) tests are performed for each SNP. A SNP is not used in the analyses disclosed herein unless it fits HWE predictions.

Rather than apply a conservative Bonferonni correction, permutation tests are used to empirically determine the appropriate p-value to determine significance, while correcting for the evaluation of multiple SNPs and haplotypes (Manly, Randomization and Monte Carlo Methods in Biology, Chapman and Hall, New York, 1991). In spite of computational intensiveness, this can be achieved using a Grid computing environment, as performed for the 71 subjects with Perlegen SNPs and gemcitabine cytotoxicity described herein.

Gemcitabine cytotoxicity: Gemcitabine cytotoxicity after drug exposure is a major phenotype that is determined in the course of phenotype-genotype association studies for the lymphoblastoid cell lines. Increasing concentrations of gemcitabine are used to perform the cytotoxicity studies in a 96-well plate format. Approximately 5×10⁵ lymphoblastoid cells are incubated overnight in each well before addition of the drug. The cells are then incubated for 48 hours with gemcitabine at 8 different concentrations, ranging from 10⁻⁴ μM to 100 μM. Cytotoxicity is determined using the MTS assay. All studies are performed in triplicate, and both IC₅₀ and LC₅₀ values are calculated. To avoid confounding factors, cytotoxicity studies are performed with equal numbers of cell lines from each ethnic group in every experiment.

Preliminary genome-wide association studies using the Perlegen SNPs and the gemcitabine cytotoxicity data (IC₅₀) were performed for these 71 cell lines as a “proof of principle” and to test methods for performing this type of study. Before performing the genome-wide association studies, the Perlegen SNPs were validated. Specifically, any SNP that deviated significantly from Hardy-Weinberg equilibrium was removed from the analysis and those with minor allele frequencies (MAF) <5% were also removed. As a result, 1.2 million SNPs were used for these preliminary genome-wide association studies.

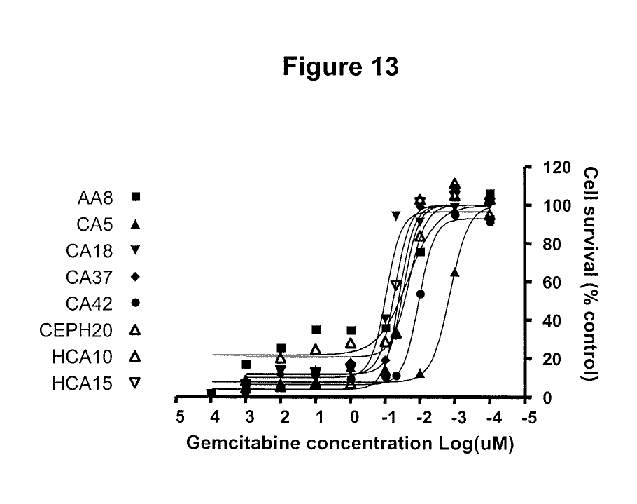

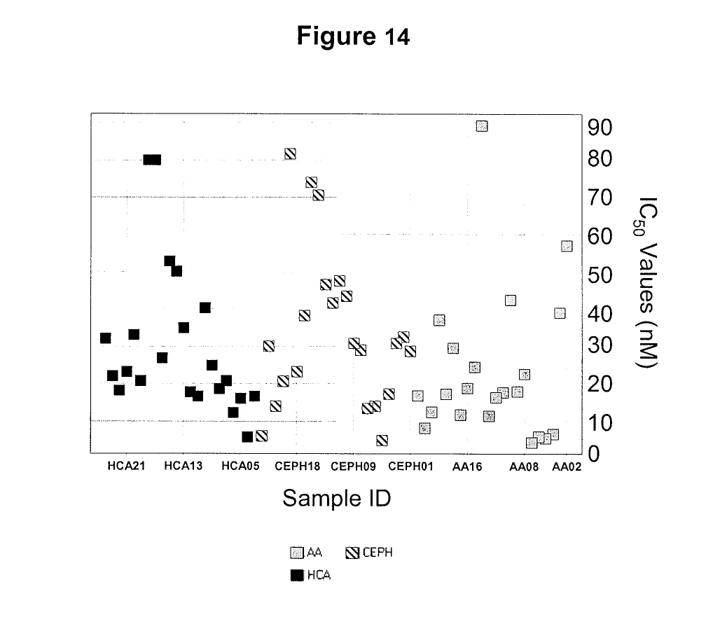

IC₅₀ data have been obtained for 71 of 203 cell lines (the 71 cell lines for which Perlegen genome-wide SNP data is available). An example of the gemcitabine cytotoxicity data for different cell lines is shown in FIG. 13. Significant variation in IC₅₀ values was observed just for the initial 71 cell lines studied (FIG. 14). Each square in FIG. 14 represents an individual sample, and the colors represent different ethnic groups. IC₅₀ values (the drug concentration that inhibited cell growth 50%) varied from 4 to 80 nM.

During this analysis, the focus was on SNPs with P values less than 10⁻⁶ because of the issue of multiple comparisons. Eighteen SNPs were significantly associated with gemcitabine cytotoxicity. These SNPs mapped to chromosomes 1, 5, 9, 15, and 18, and several were “clustered.” Studies are conducted to determine whether these SNPs are present within or close to genes and, if so, whether they are functionally significant. These SNPs also are mapped on the HapMap to identify the haplotype blocks and tag SNPs in those blocks. Such analysis can lead to the identification of “non-pathway” genes involved in gemcitabine sensitivity and resistance. Once these genes are identified, studies are conducted to determine whether they might be involved in gemcitabine sensitivity and/or resistance, using overexpression or siRNA experiments to test possible mechanisms involved. If the genes appear to be involved in gemcitabine response, selected genes are resequenced to obtain more complete gene sequence variation data for use in further analyses and functional testing.

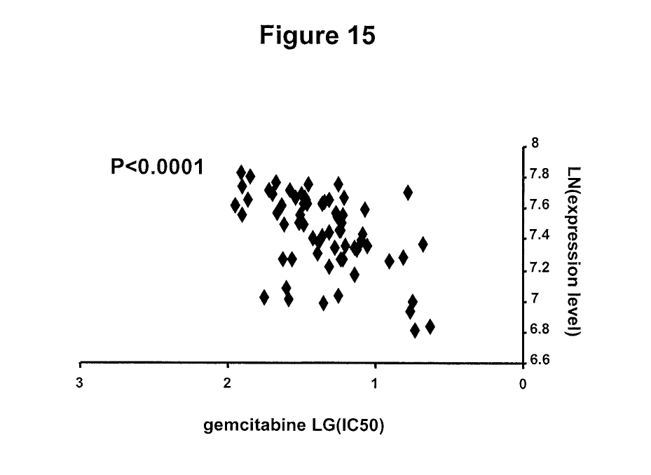

The initial gemcitabine IC₅₀ data for these 71 cell lines were used to perform preliminary association studies with phenotypes such as mRNA expression and genotypes for genes in the gemcitabine pathway. Significant associations were observed for several genes in the pathway. Biological replicates were performed to exclude the possibility that the phenotypic variation might be due to biological change in the cell lines over time. Genes showing significant correlation between expression level and gemcitabine cytotoxicity included two 5′-NTs and one of the RR genes. The correlation between IC₅₀ values and expression level for one of the 5′-NTs is shown in FIG. 15. Each symbol represents one cell line. Expression levels were log₂ transformed, and IC₅₀ values were log₁₀ transformed. Resistant and sensitive cell lines also were identified based on the IC₅₀ values, and expression profiles between resistant and sensitive cell lines were compared. Based on these initial analyses, there are significant differences in expression level between resistant and sensitive cells. Genotype-phenotype correlations are performed to determine whether genetic variation segregates with differential gene expression between sensitive and resistance cell lines.

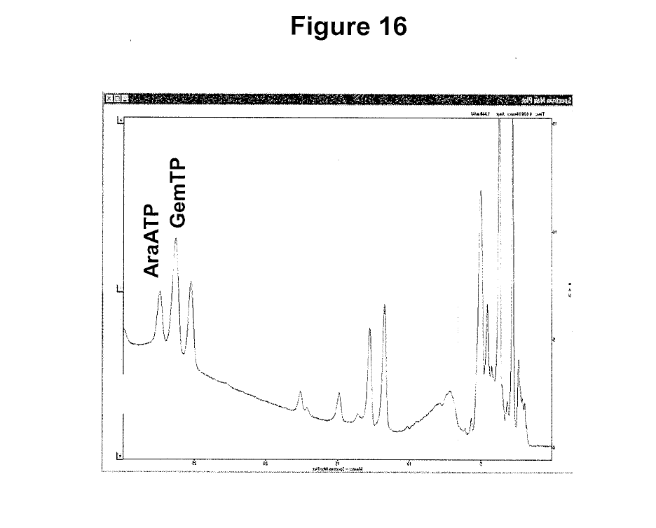

Gemcitabine intracellular metabolites: Intracellular gemcitabine metabolite levels after drug exposure are obtained for use as a phenotype to perform both pathway-based and genome-wide genotype-phenotype correlation analyses. Cytotoxicity is mainly due to active phosphorylated metabolites of gemcitabine, dFdCTP and dFdCTP. The accumulation of dFdCTP in solid tumors and leukemia cell lines is dose and exposure time-dependent, and a longer retention of dFdCTP has been associated with increased drug sensitivity (van Moorsel et al. (2000) Biochim Biophys Acta 1474:5-12; and Bergman et al. (2002) Drug Resist Update 5:19-33). Therefore, it is important to determine whether levels of intracellular metabolites correlate with cytotoxicity in the lymphoblastoid cell lines—as is true of tumor cell lines. Studies also are conducted to correlate intracellular gemcitabine metabolite concentrations with sequence variation for genes in the gemcitabine pathway. An HPLC assay is used to measure intracellular metabolites (parent drug, di- and tri-phosphate metabolites). The assay is optimized using 10⁸ cells treated with optimal concentrations (IC₅₀ values) of gemcitabine for various times (4 hours, 8 hours and 24 hours). FIG. 16 shows an HPLC chromatogram for dFdCTP using AraATP as an internal control.

Post-drug expression array data: Although every isoform for each gene family is not expressed in lymphoblastoid cells, the entire gemcitabine pathway, including transporters, metabolic enzymes, and drug targets are expressed. Basal gene expression levels for these lymphoblastoid cell lines have been determined. Post-drug exposure expression array studies also are performed. Post-drug exposure expression array studies are performed on selected resistant and sensitive cell lines based on criteria developed by the NCI for cytotoxicity studies of the NCI-60 cell lines. Sensitive and resistant cell lines are defined as those with IC₅₀ values outside of 1.6 standard deviations (0.8 SDs on each side) of the mean value, based on the distribution of IC₅₀ values for all 203 cell lines. Differences in levels of gene expression between baseline and post-drug treatment constitute an additional phenotype that is used to perform both pathway-based and genome-wide SNP association studies.

mRNA isolation and hybridization: Expression array assays are performed using Affymetrix U133 Plus 2.0 GeneChips. The conditions for these assays will be optimized with three different incubation times (6, 12, and 24 hours). In order to have adequate power, conditions are chosen that show the greatest differential gene expression levels between sensitive and resistant cell lines, realizing that specific gene regulation is time-dependent. Once those conditions are established, resistant and sensitive cell lines are cultured under those conditions, and RNA will be isolated. The inventors have performed expression array assays to measure basal gene expression in these cells. Total RNA is extracted from the cell lines using the RNeasy kit (Qiagen, Valencia, Calif.). To maintain consistency among samples, RNA quality assessment is performed using the Agilent 2100 bioanalyzer prior to sample preparation for microarray analysis. The RNA is then reverse-transcribed and biotin labeled for hybridization with Affymetrix U133 Plus 2.0 GeneChips.

Probe verification and data normalization: The probe sets on the GeneChips have been verified. Specifically, the target sequence for each probe set was obtained and those sequences were used to query NCBI's refseq database using the BLASTn program. If the target sequence matched the expected mRNA sequence and did not hybridize with any other loci, it was assumed that the expression data for that probe set accurately reflected expression level for the indicated mRNA in the lymphoblastoid cell lines. 26,653 probe sets were judged to be specific for their target genes. Normalization of array data is required to minimize variation due to factors such as chip handling, signal intensity etc. All arrays are normalized using the “fastlo” version of cyclic loess (Ballman et al. (2004) Bioinformatics 20:2778-86).

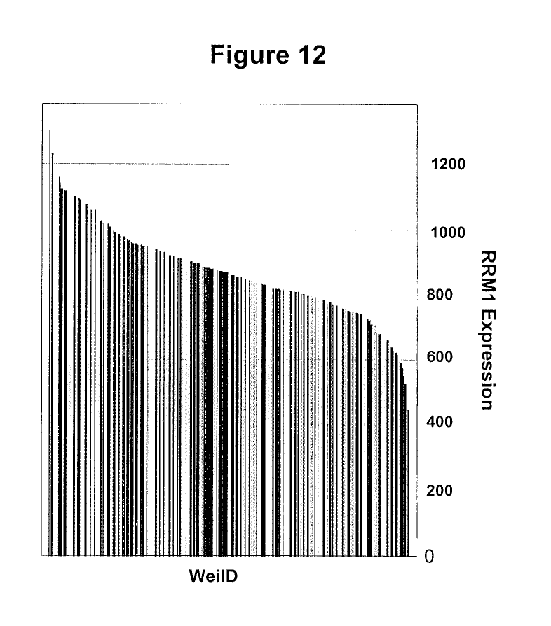

Expression array studies were performed with all 203 cell lines using Affymetrix U133 Plus 2.0 GeneChips. DNA isolated from these same cells had been used to resequence all genes encoding proteins in the gemcitabine pathway. Approximately one third of the total repertoire of human genes was expressed in these cells, including virtually all of the genes in the gemcitabine transport, metabolism and effect pathway (Table 1). The probe sets were validated, since some of the probe sets were aligned with multiple genes. Expression levels were found to vary greatly among genes. The largest variation in expression level was 20-fold, while most genes displayed 2 to 3-fold variation in expression among the 203 individual samples, including genes encoding ribonucleotide reductase (RRM1, RRM2, RRM2B) and genes encoding kinases that catalyze gemcitabine phosphorylation (CMPK, DCK). FIG. 12 shows the variation in expression for the RRM1 gene in all 203 cell lines. These expression data are be one of the phenotypes that will be correlated with genotype, as well as with other phenotypes, as discussed herein.

Genome-wide association studies with concentrations of gemcitabine metabolites, gemcitabine cytotoxicity in lymphoblastoid cells and differences in levels of gene expression before and after gemcitabine treatment in lymphoblastoid cells selected on the basis of gemcitabine IC₅₀: Prior to association analyses, the quality of genotyping is evaluated by removing SNPs that depart from HWE (p<0.001) or that have call rates <90%. To perform genome-wide associations of gene expression with SNPs, the correlation between expression, IC₅₀ values, and levels of intracellular metabolites (adjusted by regression for gender and other potential confounders) and SNP genotypes is measured using Pearson correlation coefficients (or Spearman correlations if sufficient evidence exists for departure from a normal distribution). Standard t-tests are used to determine whether correlations differ significantly from zero. To evaluate the effect of gemcitabine on gene expression, differences in gene expression are determined between pre- and post-gemcitabine treatment, and the differences are used as a phenotype for genome-wide associations. All expression arrays are normalized by a Fastlo method that yields normalized values similar to cyclic loess and quantile normalization, but is much faster and is implemented in SPLUS/R (Ballman et al. (2004) Bioinformatics 20:2778-86). Furthermore, expression measures are analyzed on a log-2 scale to remove skewness. To control for multiple testing of many SNPs, randomization p-values are calculated to determine whether the most extreme correlations differ from zero by randomizing the phenotypes (10,000 randomizations). In addition, q-values for false-discovery are calculated according to the methods of Storey ((2003) Proc Natl Acad Sci USA 100:9440-5).

Correlations among three phenotypes: gemcitabine cytotoxicity using IC₅₀ values, level of gemcitabine intracellular metabolites, and gene expression levels: To test the association among gene expression level, cytotoxicity and levels of gemcitabine intracellular metabolites, Pearson correlation coefficients are used. Standard t-tests are used to determine whether correlations differ significantly from zero.

Power to detect single SNP genetic associations: Power calculations were performed to estimate the minimum detectable R² for associations between the quantitative phenotypes of cytotoxicity and metabolite levels and the genetic effect of a causative locus based on the analysis of a single nucleotide polymorphism (assuming the SNP is in high LD with the causative locus). The calculations assumed a sample size of 203 cell lines, minor allele frequency of 0.05, additive genetic model, and a stringent alpha level of 0.001. After standardizing the phenotypes, there was 80% and 90% power to detect a minimum R² of 8.0% and 10%, respectively. Power for difference in gene expression level after treatment with gemcitabine was computed for 75 or 100 cell lines based on a model assuming a minor allele frequency of 10% and type I error rate of 0.01. There was 80% power to detect a minimum R² of 14% and 11%, for a sample size of 75 cell lines or 100 cell lines, respectively.

Power to detect haplotype effect for quantitative phenotypes (cytotoxicity and metabolites) for 203 cell lines: The non-central F distribution was used to compute power. It was previously found that no more than 20 haplotypes in a gene have frequencies greater than 1%. Therefore, 20 was used as a conservative estimate of the number of regression coefficients and significance level of 0.05, 0.01 and 0.003 (Bonferroni correction for 15 haplotype tests for 15 genes). For the 203 cell lines, there will be 80% power to detect a minimum R² of 10%-15.5% and 90% power to detect a minimum R² of 12.5%-17.5% when the significance level ranges from 0.05 to 0.003, respectively.

### Genotype-Phenotype Association Studies Using DNA from Patients with Pancreatic Cancer Treated with Gemcitabine

Tag SNP selection: Haplotype tag SNPs (htSNPS) as well as linkage disequilibrium SNPs (LD SNPs) are selected on the basis of the resequencing data for genes involved in the gemcitabine pathway as well as genes outside of the gemcitabine pathway selected on the basis of the results of genome-wide association studies performed with all 203 lymphoblastoid cell lines.

The approach of Stram et al. is used for tag SNP selection (Stram et al. (2003) Hum Hered 55:27-36). By selecting “tag” SNPs, reduce the number of SNPs for genotyping is reduced without a major loss of information (Johnson et al. (2001) Nat Genet 29:233-7). Since the resequencing studies do not cover the entire gene but only the coding region and regulatory regions, tag SNPs are used to query SNPs that are outside of the regions resequenced but are in linkage disequilibrium with SNPs identified within the resequenced regions. SNPs from the HapMap are superimposed over the gene resequencing results to obtain as much information as possible with regard to SNPs in individual gene or vice versa. SNPs also are mapped in genes identified through genome-wide association to the HapMap, and tag SNPs are selected based on the haplotype block. The algorithm for choosing htSNPs involves 1) estimating haplotype frequencies by use of the EM algorithm; 2) choosing haplotypes to tag; and 3) evaluating all possible subsets of SNPs, and determining how well each subset explains the variation of each of the targeted haplotypes. Because rare haplotypes require extremely large sample sizes for association studies, haplotypes with frequencies of at least 5% are tagged. The variation “explained” is the percentage variation, R². Each targeted haplotype has its own R² and, to prevent information loss, the minimum of these R² values should be large. For a sample size of N, ambiguity of haplotypes reduces the effective sample size to R² N. A minimum R² of 0.9 is required, so that the effective sample size will not be less than 90% of the true sample size. Although the htSNP method reduces the number of SNPs required to accurately tag haplotypes, it may not necessarily capture long-range LD as efficiently as pair-wise measures of LD. To allow for that possibility, the LD-Select method (available online at droog.gs.washington.edu/ldSelect.html) also will be applied.

Genotyping patient DNA: DNA samples obtained from patients with pancreatic cancer who were treated with gemcitabine are genotyped using htSNPs and LD SNPs, as well as any SNPs showing significant associations. Based on past experience, it is expected that each gene has a total of approximately 15-20 ht and LD SNPs. Any nonsynonymous cSNPs also are included, as are any SNPs showing functional significance in the cell culture studies or showing significant association as reported in the literature. The Illumina GoldenGate™ Platform is used to genotype the 600 patient DNA samples (Oliphant et al. (2002) Biotechniques Suppl:56-8, 60-1). Positive and negative controls are included with each assay. Twelve microsatellites are pretested in all samples to assure DNA quality. Ambiguous calls are repeated with a different genotyping method. For VNTRs as well as other “length” polymorphisms, the “GenScan” system that utilizes an ABI DNA sequencer and fluorescence-labeled primers will be used to determine amplicon length.

Genotype-phenotype association studies with patient DNA: Clinical translational studies utilize the Mayo-NIH Pancreatic Cancer SPORE, a unique resource that has already collected over 1500 DNA samples from pancreatic cancer patients—1200 of whom suffered from adenocarcinoma. 95% of the patients are Caucasian; 55% are male, with a mean age in the late 60's. These patients have mixed disease stages. Approximately one third of the patients (350) from whom samples were collected were at stage 1 and stage 2 and had surgical procedures. Approximately one third (350) of the patients were at stage 2 and 3 and had local advanced disease. The remainder, over 400 patients, had metastatic disease. Because of power issues, all samples from patients treated with gemcitabine are included, and adjustments are made for all confounding factors such as age, gender, disease stage, and treatment duration during the analysis.

Tumor response has traditionally been the primary efficacy endpoint used to assess cytotoxic chemotherapy in pancreatic cancer (Johnson et al. (2003) J Clin Oncol 21:1404-11). Because of the short life expectancy of pancreatic cancer patients and difficulty in obtaining accurate tumor measurements, overall survival has been the primary clinical metric for this tumor and is used as a study endpoint in most trials (Louvet et al. (2005) J Clin Oncol 23:3509-16; and Hochster et al. (2006) Cancer 107:676-85). Median survival after gemcitabine therapy is approximately 6 months, and since over 75% of the SPORE patients are deceased, it is possible to use overall survival time as an endpoint to access gemcitabine's effect. In addition to survival time as a primary endpoint, use time to progression also is used as a secondary endpoint, especially for those with local advanced or metastatic disease. At the same time, genotype-phenotype association studies are performed with phenotypes related to gemcitabine toxicity, using neutrophil and platelet counts as indicators for the two most common side effects, neutropenia and thrombocytopenia.

Power to detect single SNP genetic associations and haplotype associations for phenotypes measured on pancreatic cancer patients treated with gemcitabine: Power calculations for the quantitative phenotypes of neutropenia and thrombocytopenia were performed to estimate the minimum detectable R² for associations between phenotypes and single SNP genetic effect. These calculations assumed a sample size of 600 pancreatic cancer patients, 80% or 90% power, minor allele frequency of 0.05, additive genetic model, and a stringent alpha level of 0.001 to adjust for some of the multiple testing issues. After standardizing the phenotypes, there was 80% and 90% power to detect a minimum R² of 2.9% and 3.5%, respectively. The power for the haplotype analysis using the quantitative traits of neutropenia and thrombocytopenia was completed in the same way as for the cell lines, using the non-central F distribution. Power to detect the genetic effect of a causative locus based on the analysis of a single nucleotide polymorphism (assuming the SNP is in high LD with the causative locus) was computed for a dominant genetic model where the median survival of patients homozygous or heterozygous for the rare allele is compared to the median survival of patients homozygous for the common allele. To have 80% power and a type 1 error of 5%, with 600 patients on gemcitabine treatment, there will be adequate power to detect a 35% difference in median survival time with a minor allele frequency of 10% or greater and a 50% difference in median survival with a minor allele frequency of 5% or greater (Table 3). With a type 1 error of 1%, there will be adequate power to detect a 50% difference in median survival with a minor allele frequency of 10% or greater (Table 4) (Therneau, Modeling Survival Data: Extending the Cox Model, New York: Springer, 2000).

TABLE 3
Number of events needed for 80% power and 5% Type I error rate,
assuming a dominant genetic model

Minor Allele Frequency

| Effect | 5% | 10% | 15% | 20% |
|---|---|---|---|---|
| 1.35 | — | 567 | 435 | 379 |
| 1.50 | 543 | 311 | 239 | 208 |
| 1.65 | 356 | 204 | 157 | 136 |

TABLE 4
Number of events needed for 80% power and 1% Type I error rate,
assuming a dominant genetic model

Minor Allele Frequency

| Effect | 5% | 10% | 15% | 20% |
|---|---|---|---|---|
| 1.35 | — | — | — | 563 |
| 1.50 | — | 462 | 355 | 309 |
| 1.65 | 530 | 303 | 233 | 203 |

### Functional and Mechanistic Characterization of SNPs in Selected Genes Associated with the Phenotypes Both within and Outside “Gemcitabine Pathway” Genes

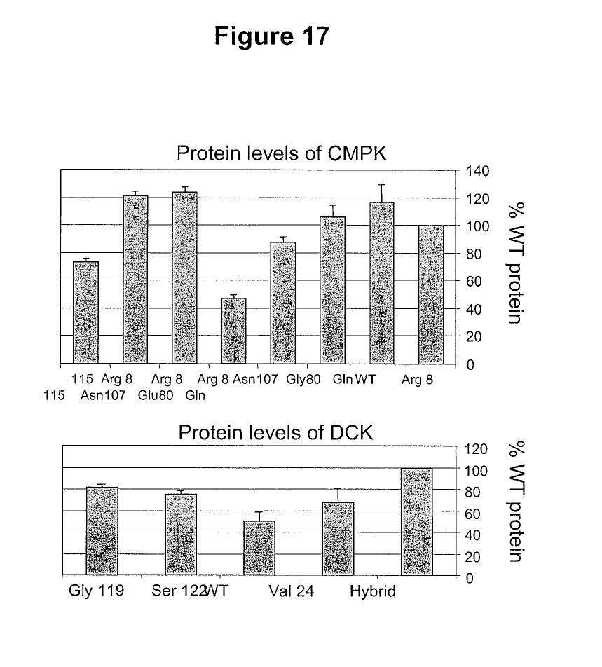

Functional genomic studies are performed to test biological mechanisms by which the identified SNPs might influence function. The initial focus is on SNPs identified through the resequencing studies involving the gemcitabine pathway. SNPs in selected genes identified in the course of the genome-wide association studies also are evaluated. If SNPs identified during the genotype-phenotype association studies do not have direct functional effects, functional tests are performed with other SNPs linked with those SNPs, with a focus on SNPs in coding or regulatory regions, especially regions with sequences that are highly conserved across species. The inventors have completed and published functional genomic studies with two deaminases, CDA and DCTD (Gilbert et al. (2006) Clin Cancer Res 12:1794-803), in the gemcitabine pathway. Functional genomic studies of two gemcitabine pathway kinases, CDK and CMPK also have been conducted. FIG. 17 shows the results of Western blot analyses for constructs containing nonsynonymous cSNPs for the CMPK and DCK genes after transient expression in COS-1 cells. Haplotypes in the 5′-FRs are studied by creating reporter gene constructs and testing their effect on transcription in mammalian cell lines. In addition, minigene constructs are created for SNPs that might disrupt mRNA splicing or stability, and their effects on mRNA levels are tested by performing real-time RT-PCR. If SNPs are not functionally significant themselves, linkage disequilibrium is determined between SNPs showing significant associations with other SNPs, with a focus on SNPs in regulatory regions and regions with high sequence homology across species. Functional studies of the linked SNPs are then performed. In some cases, additional resequencing may be done for regions containing SNPs that are highly linked to SNPs identified during association studies in order to identify additional SNPs that might be functionally significant. These functional studies of SNPs will add biological plausibility to the genotype-phenotype association data.

Nonsynonymous cSNPs: For nonsynonymous cSNPs, mammalian expression constructs are created for the wild type (WT) and variant sequences. The variant constructs are created by circular PCR using WT constructs as template. Since circular PCR can induce additional mutations, the SNPs are “back mutated” to the WT sequence to ensure that phenotypes resulting from variant SNP constructs are not due to mutations induced during the circular PCR. These constructs are used to transiently transfect mammalian cells such as COS-1 cells that express few of the proteins of interest. All results are corrected for transfection efficiency by cotransfection with beta-galactosidase. The inventors have completed functional studies for nonsynonymous cSNPs in the two deaminase genes present in the gemcitabine pathway (Gilbert et al. (2006) Clin Cancer Res 12:1794-803), and are in the process of performing functional studies for nonsynonymous cSNPs in the CDK and CMPK genes. Western blot analysis and enzyme assays are performed using preparations from cells transfected with these constructs. Enzymes assays are performed based on published and validated assays (Nordlund and Reichard (2006) Annu Rev Biochem 75:681-706; Gilbert et al., supra, and Bretonnet et al. (2005) FEBS Lett 579:3363-8).

Promoter region SNPs: Reporter gene constructs that contain common 5′-FR haplotypes are created, and luciferase activity is assayed in selected cell lines. In some cases, electrophoresis mobility shift assays are performed, as well as searches of transcription factors binding motif databases to help identify transcription factor binding motifs that are altered by SNPs to help identify the transcription factor(s) involved in the regulation of transcription.

Rather than focusing on individual SNPs, common (frequency of >5%), naturally occurring 5′-FR haplotypes are studied. Cross species sequence comparisons are first performed to identify regions that share >75% homology between mouse and human, and to determine if any SNPs are within these regions. Most constructs are created by PCR amplification of Coriell Institute DNA samples with known 5′-FR haplotypes. The amplicons are cloned into pGL-3 Basic (Promega, Madison, Wis.) upstream of the firefly luciferase open reading frame (ORF). All inserts are sequenced in both directions to assure sequence integrity. These constructs are used to transfect at least two cell lines that express the protein of interest, together with pRL-TK DNA. The renilla luciferase activity expressed by pRL-TK is used as a control for transfection efficiency. The cells also are transfected with pGL-3 Basic without insert as an additional control. A dual luciferase assay (Promega) is used to measure luciferase activity, and results are expressed as the ratio of firefly to renilla luciferase light units.

EMS assays are performed when reporter gene studies show that a polymorphism in a 5′-FR haplotype might influence transcription or when any SNPs in regulatory regions show a significant association with phenotype. On the basis of the results of the reporter gene experiments, appropriate cell lines are selected for the isolation of cell extracts as described by Jiang and Eberhardt ((1995) Nucl Acids Res 23:3607-3608). Sense and antisense oligonucleotides for probes are annealed, and double-stranded probe DNA is 3′-end labeled with α-³²P[dCT] using the E. coli DNA polymerase Klenow fragment. Probes are purified with Sephadex G25 columns. DNA-protein binding occurs during incubation of the probes with cell extract, and electrophoresis is performed on 5% acrylamide gels, followed by autoradiography. Competition experiments are performed with excess nonradioactive probe, as well as probes that include nonspecific sequence and probes with the “alternative” SNP sequence. “Supershift” assays also are performed if antibodies for candidate transcription factors are available.

SNPs in exon-intron splice junctions or 3′-UTRs: For SNPs located in intron-exon splice junctions, SNPs in the 3′-UTR, or SNPs showing significant association with level of mRNA expression in the Coriell cell lines, minigene constructs containing the SNPs of interest are created, and RT-PCR or real time RT-PCR is performed to assess alternative splicing and mRNA stability. These studies are conducted with the TAQMAN™ system (Applied Biosystems, Foster City, Calif.), which takes advantage of the 5′-exonuclease activity of Taq polymerase to measure the quantity of target sequence present in the sample. In selected cases, this approach also is used to quantitate mRNA from the lymphoblastoid cells to confirm the expression array data. GAPDH is used as an internal standard for those studies.

### Example 3

### Association of Gemcitabine and AraC Cytotoxicity with Gene Expression in Lymphoblastoid Cell Line Panel

Cell lines: 197 EBV-transformed B lymphoblastoid cells derived from 60 Caucasian-American (CA), 54 African-American (AA) and 60 Han Chinese-American (HCA), as well as 23 CEPH (also CA) subjects were purchased from the Coriell Institute (Camden, N.J.). These suspension cell lines were obtained at different times, with 40% stored for more than 10 years, and were maintained in RPMI medium 1640 with 1% L-glutamine (Mediatech, Herndon, Va.) supplemented with 15% Fetal Bovine Serum (FBS) (Mediatech). Cell lines were maintained for 2-3 passages and seeded at a certain density to be ready for experiments at 37° C. in a 95% humidified and 5% CO₂ atmosphere. The human breast cancer cell line, MDA-MB-231, was obtained from the American Type Culture Collection (ATCC; Manassas, Va.) and cultured at 37° C. in DMEM supplemented with 10% FBS and 2 mM L-glutamine. The human pancreatic cancer cell line, SU86, was a gift from Dr. Dan Billadeau (Department of Immunology and Division of Oncology Research, Mayo Clinic College of Medicine). The SU86 cell line was maintained in RPMI medium 1640 with 1% L-glutamine and 10% FBS.

Drugs: AraC was purchased from Sigma-Aldrich (St. Louis, Mo.), and gemcitabine (dFdC) was from Eli Lilly (Indianapolis, Ind.). Stock solutions (100 mM) of these drugs were dissolved in DMSO and were frozen at −20° C. for future use.

Gemcitabine and AraC cytotoxicity assay: Cytotoxicity assays were performed with 197 human lymphoblastoid cell lines using CYTOTOX 96® Non-Radioactive Cytotoxicity Assay (Promega Corporation, Madison, Wis.), which is a colorimetric method for detection of viable cells based on the detected amount of bioreduced formazan product of combined solutions of a tetrazolium compound (MTS) and an electron coupling reagent (PMS) at 490 nm. Specifically, once cells grew at an exponential phase, 90 μl of cell suspension were placed into a 96 well flat plate (Corning, Corning, N.Y.) at a density of 5×10⁴ cells/well. At least 1 hour after placing the cells, 10 μl of gemcitabine or AraC with a series of concentrations at 10-fold-dilution were added into each well, and the cells were incubated for 72 hours at 37° C. Experiments were performed in triplicate for each concentration. Medium alone was used as a blank, and cells treated with DMSO were used as controls for every plate. At end of the incubation, 20 μl combined MTS/PMS solution were added into each well and incubated at 37° C. for an additional 1-2 hours. The amount of soluble formazan was measured with a SAFIRE™ microplate reader (Tecan A G, Switzerland). An absorbance for the control cells ranging from 0.8 to 1.3 was considered to meet the standard of cytotoxicity assays for the analysis. The final cell viability for each well was calculated using the following formula: relative survival cell number=absorbance (drug-treated cells−blank)/absorbance (control cells−drug-treated cells). During the entire process from cell culture to cytotoxicity analysis, all cell lines were grown exponentially without antibiotics and were handled by one person under the same condition to minimize the variation introduced by handling. The final dose-response curve for each cell line was plotted based on either 4 parameter logistic with top=100%, or 4 parameter logistic with bottom=0% using an R package. GI₅₀ values at each concentration for each cell lines were then calculated based on the dose response curve. Twelve randomly selected lymphoblastoid cell lines were used to repeat the cytotoxicity studies three months later. In addition, to functionally characterize the effect of the candidate genes on the sensitivity to both drugs, drug cytotoxicity with human tumor cell lines also was analyzed using an MTS assay. The experimental procedures were similar to those for the lymphoblastoid cell lines, except that the cells were incubated overnight in 96 well plates before addition of the two drugs.

Gene Expression: Whole genome expression data for 197 cell lines was obtained using an Affymetrix U133 plus 2.0 expression array chip (Affymetrix, Inc., Santa Clara, Calif.). The RNA extraction and the expression array assays were performed followed the Affymetrix GeneChip expression technical manual. Specifically, total RNA samples from the 197 lymphoblastoid cell lines were extracted using Qiashredder and Qiagen RNEASY® Mini kits (Qiagen Inc., Valencia, Calif.), followed by measurement of A_{260/280} ratio. All RNA samples had A_{260/280} ratios greater than 1.8. Before the assay, RNA quality was tested using an Agilent 2100 Bioanalyzer. The Bioanalyzer gel profile should exhibit a 28S band that is 2 times more intense than 18S ribosomal RNA to indicate good quality RNA. Biotin-labeled cRNA, produced by in vitro transcription, was fragmented and hybridized to Affymetrix GeneChip Human Genome U133 Plus 2.0 Arrays at 45° C. for 16 hours and then washed and stained using the GeneChip Fluidics, followed by scanning by a GeneArray Scanner. The expression array data was normalized using both GCRMA and Fastlo, providing the ability to focus on genes that showed significant association with drug cytotoxicity phenotype when using both normalization methods. The GeneChip contained over 54,000 probe sets that were designed based on build 34 of the Human Genome Project, and 26,653 probe sets were validated based on build 36 and RefSeq RNA database using the BLASTn program for the future correlation study. These 26,653 probe sets were used in the subsequent correlation study.

Genome-wide Association studies between Cytotoxicity (GI₅₀ values) and Gene Expression: A genome-wide correlation analysis was performed between gene expression and GI₅₀ values for both gemcitabine and AraC. Correlation with each standardized cytotoxicity phenotype and expression phenotype was completed using Pearson's correlation r and test statistic of

$$t = ( \frac{r}{\sqrt{1 - {r}^{2}}} ) \sqrt{n - 2} ∼ t ( df = n - 2 ) .$$

The analysis was adjusted for a series of confounding factors including race, gender and the time between submission of the cells to Coriell and the time the cells obtained from Coriell.

Top candidate genes that showed significant correlation with drug cytotoxicity using two different normalization methods were mapped to the network using the Ingenuity Pathway Analysis (IPA) program.

Real-time quantitative reverse transcription-PCR (QRT-PCR): Total RNA samples were isolated from culture cells using the Qiagen RNEASY® kit according to the manufacturer's protocol, followed by QRT-PCR with the 1-step, Brilliant SYBR Green QRT-PCR master mix kit (Stratagene, La Jolla, Calif.). Briefly, a series of 10× primer mixtures was purchased from Qiagen. Total RNAs and specific primers for each gene of interest were mixed in a total of 25 μl reaction and QRT-PCR was carried out in Stratagene MX3005P™ Real-Time PCR detection system. Experiments were performed in triplicate, and β-actin was used as an internal control for each gene. PCR conditions were as follows. cDNA synthesis: 30 minutes at 50° C.; reverse transcriptase inactivation: 10 minutes at 95° C.; and 40 cycles of PCR cycling and detection: 1 minute at 95° C. and 30 seconds at 60° C. Relative expression levels of target genes were calculated after normalization of β-actin as an internal control. For each target gene, a set of reactions using the reverse transcribed Universal Human reference RNA (Stratagene) at five different concentrations was included to construct a standard curve. Control reactions without RNA template also were included.

Transient transfection and RNA interference: The human breast cancer cell line, MDA-MB-231, and the human pancreatic cancer cell line, SU86, were used for siRNA studies. The LIPOFECTAMINE™ RNAiMAX reagent (Invitrogen, Carlsbad, Calif.) was used for transient transfection of siRNA according to the manufacturer's instructions. Briefly, cells were growing adhesively until they reached 30-50% confluence in a 6-well plate, and then transfected. siRNAs including NT5C3-siRNA, FKBP5-siRNA and Allstars negative control siRNA (Qiagen) at a final concentration of 50 nM, as well as 5 μL, of LIPOFECTAMINE™ RNAiMAX reagent, were preincubated with 250 μL, reduced serum medium (Invitrogen) for 5 minutes at room temperature before being mixed together. After incubation of the siRNA and LIPOFECTAMINE™ reagent mixtures for 20 minutes at room temperature, this mixture was added to cells in 2 ml culture medium supplied with 10% FBS. Cells were harvested for further assays 48 hours post-transfection.

Western blotting assay: Western blotting after transient transfection was carried out 48 hours post-transfection. Cell pellets (2×10⁶ cells) were harvested and rinsed twice with PBS. Cell extracts were prepared with lysis buffer with proteinase inhibitor cocktail, followed by protein estimation using a Bradford assay kit according to the instructions of the manufacturer (Bio-Rad Laboratories; Hercules, Calif.). Sequentially, 30 μg of total protein were equally loaded and separated on 12% SDS/PAGE gels. Samples were transferred onto PVDF membranes, and the membranes were incubated with primary antibodies overnight at 4° C. and then HRP-conjugated IgG at room temperature after washed with three times of TBST. Signals were detected using an enhanced chemiluminescence detection system (Amersham Biosciences). Primary antibodies against NT5C3, FKBP56, and β-actin (internal control) were obtained from GenWay Biotech (San Diego, Calif.), Abcam, (Cambridge, Mass.), and Novus Biologicals (Littleton, Colo.), respectively.

Detection of intracellular gemcitabine and AraC active metabolites: The mechanism of cytotoxicity for both gemcitabine and AraC is due mainly to formation of active phosphorylated metabolites. Levels of these intracellular metabolites is partially determined by the balance between phosphorylation and dephosphorylation. To measure the intracellular metabolite levels in drug-treated lymphoblastoid cell lines, an HPLC assay was developed to measure AraCDP, AraCTP as well as dFdCDP and dFdCTP. Briefly, nucleotide extracts were prepared according to modified methods previously reported by Van Haperen et al. ((1996) Biochem Pharmacol 51:911-918). Specifically, cells were treated with gemcitabine or AraC for 8 hours using the average GI₅₀ concentration for each drug. Five×10⁶ cells were centrifuged and washed with ice-cold phosphate buffered saline (PBS), followed by resuspension in 135 μL, of ice-cold PBS with 15 μL, of 100 μM AraCTP or dFdCTP as internal standards. Subsequently 50 μL, of 40% ice cold TCA was added, and the mixture was vortexed for 1 minute and chilled on ice for 20 minutes, followed by centrifugation. The supernatant was neutralized by adding 400 μL, of freshly prepared trioctylamine:trichlorotrifluoroethane (1:4). After centrifugation at 4° C. for 1 minute, the aqueous phase (nucleotide extract) was removed and stored at −20° C. for HPLC analysis.

Nucleotide analogue metabolites were separated from native nucleotides on a ZirChrom SAX HPLC column in HPLC assay. Briefly, 100 μL, of nucleotide extracts were injected on the column and eluted with a gradient mixture starting at 100% A and finishing with 65% B over 75 minutes. Mobile phase A was 10 mM K₂HPO₄ and 40 mM NaCl, pH 6.8. Mobile phase B was 100 mM K₂HPO₄ and 400 mM K₂HPO₄, pH 6.8. Detection was performed by monitoring the absorbance with a photo-diode array between 240-290 nm to obtain a typical chromatogram. The amount of intracellular metabolites in 5×10⁶ cells was quantified with a standard curve prepared by spiking the 5×10⁶ untreated control cells with pure compound, immediately followed by nucleotide extraction.

Caspase-3/7 activity assay: The caspase-3 activity of siRNA-transfected cells was detected according to the manufacture's protocol using CASPASE-GLO® 3/7 Assay kit (Promega BioSciences, San Luis Obispo, Calif.). Once a proluminescent caspase-3/7 substrate containing the tetrapeptide sequence DEVD is cleaved by caspase-3/7, it will release a substrate for luciferase (amino-luciferin). The luminescent signal is proportional to caspase-3/7 activity thus can be used to indicate apoptosis. siRNA-transfected cells (100 μl) at a density of 5,000 cells per well were seeded into 96-well plates overnight, and the cells were treated with increasing concentrations of gemcitabine and AraC for 72 hours. CASPASE-GLO® 3/7 Reagent (100 μl; an equal volume to the cell suspension) was added and incubated for 1 hour at room temperature, followed by detection of luminescence with a luminometer. Wells containing culture medium alone were used as controls.

Statistical methods: Values of cytotoxicity results performed in three wells for each concentration were averaged. Three different logistic functions (four parameter, three free parameters with a fixed asymptote at 0%, and three free parameters with a fixed asymptote at 100%) were used to fit the data with the R package “drc” (cran.r-project.org/doc/packages/drc.pdf). The best fit of the three logistic models with the lowest mean square error was used to determine LC₅₀ values. Two cell lines were excluded from the gemcitabine cytotoxicity analysis for technical reasons. Expression array data were normalized on a log base 2 scale, using both GCRMA and Fastlo (Ballman et al. Bioinformatics (2004) 20:2778-2786; and Zhijin et al. Forrest Spencer J. Am. Statist. Assoc. (2004) 99:909). The normalized expression data were then regressed on gender, race, and time since the Coriell Institute acquired the cell line (dichotomized at 10 years). Residuals from this regression were then standardized by subtracting the mean residual for individual probe sets and dividing by the standard deviation to derive a “standardized adjusted expression value.” LC₅₀ values were log transformed and adjusted in a fashion similar to that described for the expression data. All analyses were based on adjusted standardized values for both expression array and LC₅₀ data. Pearson correlation coefficients were then calculated for LC₅₀ and expression levels. A Wald test was used to test for a non-zero correlation. Multiple testing for the most significant probe sets was performed using 10,000 permutation. Percent variation in LC₅₀ explained by variation in pathway gene expression was calculated based on the coefficient of determination (R²) using a multiple regression model between GI₅₀ values and individual probe sets. Differences in intracellular metabolites between randomly selected resistant and sensitive cell lines were determined with student's T-test. Correlation between expression array and QRT-PCR or intracellular metabolites was determined by Pearson correlation. Agreement between cytotoxicity performed at two different times was measured using an intra-class correlation coefficient (ICC). The ICC was calculated as the ratio of variation among samples over total variation in log LC₅₀ values, and 95% confidence intervals were based on the F distribution. Ingenuity pathway analysis was performed by calculating the p-value of the probability of finding a set of genes within a given pathway. Fischer's exact test was used to calculate the p-values.

### Gemcitabine and AraC Cytotoxicity

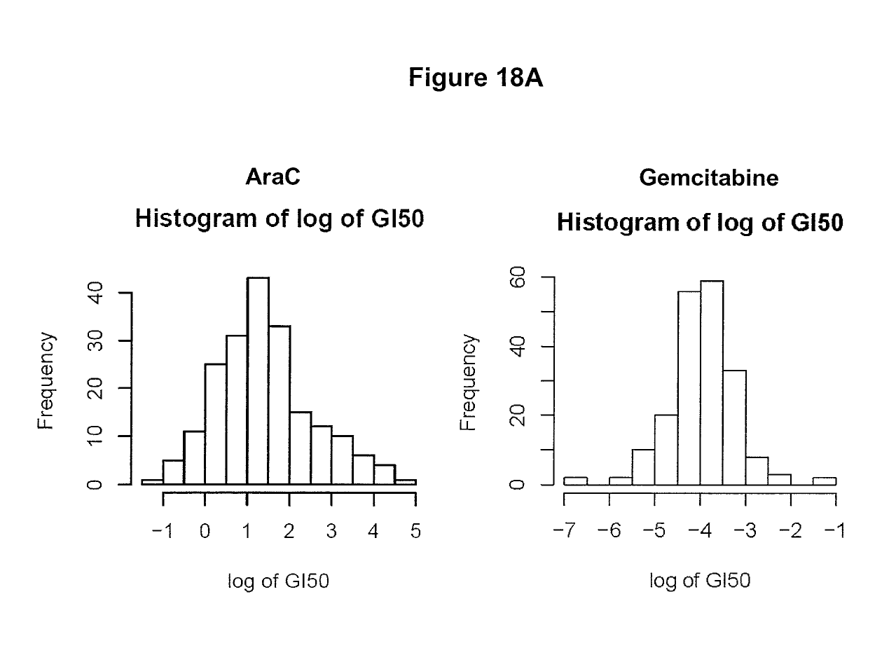

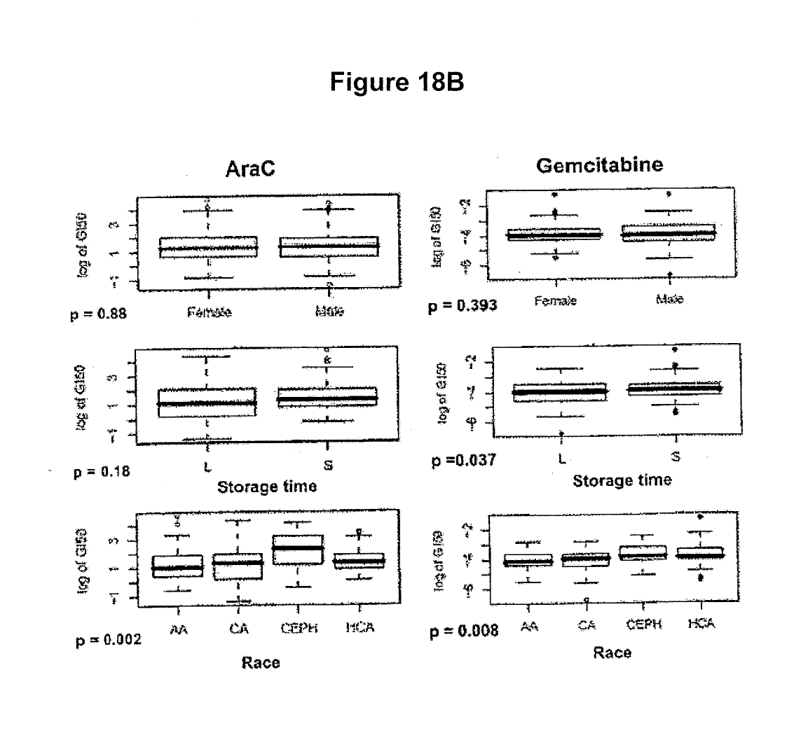

To identify biomarkers across the entire genome that would help to predict drug sensitivity and resistance to AraC and gemcitabine, a data-rich cell-based model system was used. As the first step, cytotoxicity studies were performed to determine variation in GI₅₀ values, an indicator of sensitivity to a drug among individuals. Increasing concentrations at a 10 fold-dilution of gemcitabine and AraC were incubated with individual cell lines for three days, and dose response curves were obtained using the R program. GI₅₀ values were derived for each cell line, and the distribution of Log transformed GI₅₀ values for 197 cell lines is shown in FIG. 18A. A wide range of distribution of GI₅₀ values was observed from the most sensitive to the most resistant cell lines for both drugs (FIG. 18A). This was consistent with the wide range of observed clinical responses. Average unadjusted LC₅₀ values for gemcitabine and AraC in these 197 cell lines were 25.34±30.7 nM and 8.4±14.3 μM (mean±SD), respectively.

Since these cell lines were obtained from four different ethnic groups (AA, HCA, CA and CEPH), and approximately half are females and half are males, the effects of race and gender on the distribution of GI₅₀ values was determined. In addition, because these cell lines were obtained by Coriell Institute at very different times, ranging from as much as 20 years between CEPH and HCA, with CA and AA in the middle, the different lengths of storage time might affect the biology of these cell lines. Therefore, the storage time was divided into less than 10 years and more than 10 years to determine the effects on GI₅₀ values. Gender did not appear to have significant effects on LC₅₀ values for either gemcitabine (p=0.39) or AraC (p=0.88). The time since the Coriell Institute acquired the cell lines had a slight effect on gemcitabine LC₅₀ values (p=0.037), but not AraC (p=0.18) (FIG. 18B). Race showed significant effects on GI₅₀ values for both gemcitabine and AraC, with slightly more resistance to both drugs in the CEPH cell lines compared to the other three groups (FIG. 18B). Thus, to avoid multiple confounding factors that might influence cell responses to drug treatments, results for gender, race and storage time were adjusted in subsequent genome-wide expression and cytotoxicity correlation studies.

A biological replication study also was performed to exclude the possibility that this phenotype might vary over time. Specifically, 12 ethnically diverse cell lines were randomly selected and cytotoxicity assays were repeated three months after the initial experiments. There was a high degree of agreement between results at the two different times for both drugs. The intra-class correlation coefficient was 0.83 (95% CI: 0.51-0.95) for gemcitabine and 0.71 (95% CI: 0.26-0.91) for AraC.

### Expression Array Analysis

Previous studies with regard to identification of biomarkers for predicting response to gemcitabine typically have focused on the variation in expression level for several genes within the known metabolism and activation pathway. However, there has been little information about gene expression across the entire genome that might affect the resistance and sensitivity of cytidine analogues. To obtain expression array data for 197 cell lines, basal gene expression analysis was performed using the GeneChip Human Genome U133 Plus 2.0 Array (Affymetrix). Each chip contained 54,000 probe sets based on the Human Genome Build 34. In subsequent association studies, however, only 26,653 probe sets were used, which were verified against RefSeq based on previous results. Expression results were normalized using two different methods to avoid the variability introduced by the normalization step. In subsequent functional studies, the focus was mainly on genes that showed significant correlation using GCRMA and Fastlo normalization methods. After normalization, expression data were adjusted for confounding factors including gender, race and storage time during the genome-wide association studies.

### Genome-Wide Association Between Expression and Cytotoxicity

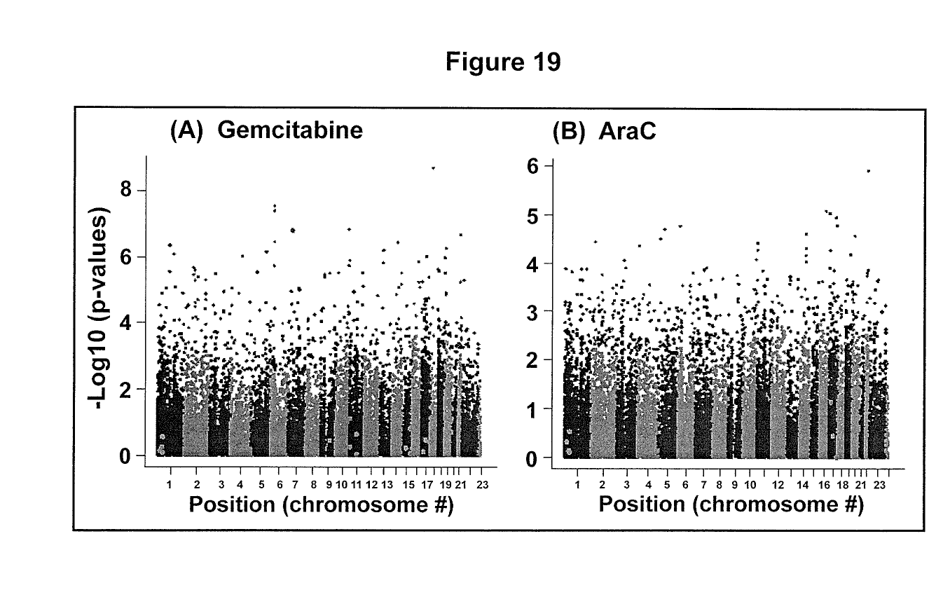

Experiments were conducted to identify top candidates that could be further functionally tested. Correlations between basal gene expression and LC₅₀ values for gemcitabine and AraC were evaluated to identify genes that might contribute to variation in cytotoxicity. The 26,653 RefSeq validated sequences among the 54,000 Affymetrix probe sets were used to perform these correlation studies. P values for individual probe sets are shown graphically in FIG. 19. The p-values for association tended to be smaller for gemcitabine than those for AraC. With the exception of one gene, NT5C3, genes encoding proteins in the “cytidine analogue pathway” (Table 1), did not display highly significant p values. NT5C3 had only one probe set, and it was significantly associated with gemcitabine LC₅₀ values (p=1.6×10⁻⁷). NT5C3 encodes a member of the nucleotidase family that catalyzes the dephosphorylation of monophosphorylated drug metabolites, thus decreasing the concentration of active drug metabolites. Expression levels for NT5C3 showed a less significant association with AraC LC₅₀ values although, among all genes within the “pathway,” it also had the smallest p-value for AraC (p=0.004). Since most previous studies have focused only on pathway genes, the effect of variation in expression for all known pathway genes on variation in LC₅₀ values was estimated. Approximately 27% of the variation in gemcitabine LC₅₀ values and approximately 11% of the variation for AraC could be explained by variation in gene expression within this intensively studied metabolic pathway.

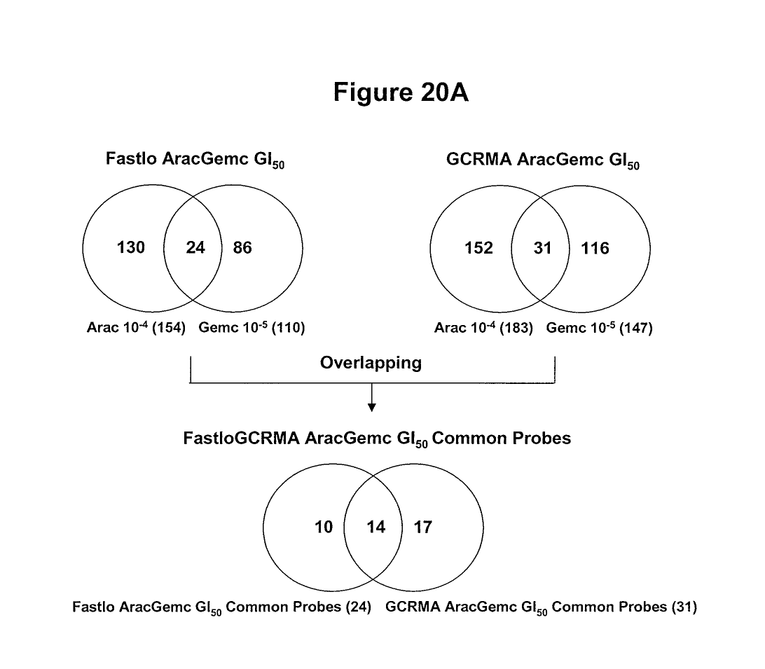

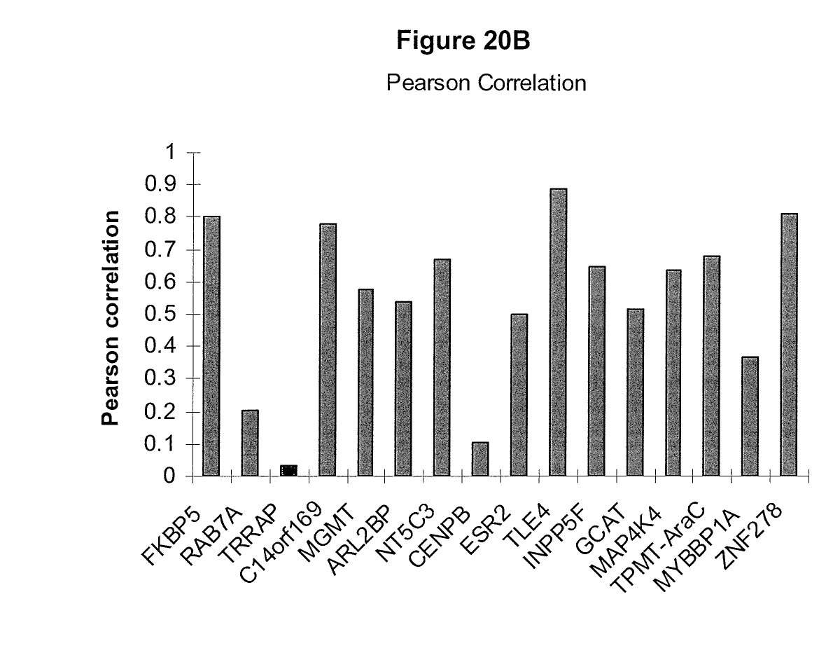

Among the 26,653 probe sets tested, 55 had p-values ≦10⁻⁶ for gemcitabine (adjusted multiple testing p-value=0.0002), and 21 had p-values ≦10⁻⁵ for gemcitabine and ≦10⁻⁶ for AraC (adjusted multiple testing p-value=0.0469). Since gemcitabine and AraC function in a similar fashion as anti-neoplastic drugs, significant genes for both drugs identified during the genome-wide studies of association between expression and LC₅₀ values were overlapped (FIG. 20A). To identify top candidate genes for each drug that could be further functionally characterized, original p values were used to rank the genes with regard to their association with drug cytotoxicity rather than as a cutoff for being statistically significant, since very few of the candidate genes pass Bonferroni correction. Therefore, a p-value cutoffs of <10⁻³ for AraC and <10⁻⁴ for gemcitabine were arbitrarily used to obtain a similar number of genes for each drug. Thirty-one probe sets were identified that were common to both gemcitabine and AraC. Among those 31 probe sets, 14 encoding 12 genes were replicated when a different method of expression array normalization, Fastlo, was used (FIG. 20B; Table 5). In addition, three non-overlapping genes with highly significant associations for either gemcitabine or AraC also are included in Table 5.

To verify expression array data for these 15 genes (18 probe sets), 12 lymphoblastoid cell lines with extreme LC₅₀ values were selected to perform real-time QRT-PCR, and the results were compared with the expression array data. Before performing QRT-PCR, the specificity of these 18 probe sets was determined by aligning the sequences of individual probes with the sequences of their presumed gene targets. As it would have been practically difficult to verify the specificity of all 26,653 probe sets, and the nonspecific probe sets will not influence the p values for the specific probe sets, probe specificity was only verified for genes determined to be worthy of further pursuing. Six probe sets targeting 6 genes lacked specificity, defined as at least 5 of 11 probes that were “non-specific.” Among the remaining genes, five showed correlation values ≧0.5 between the QRT-PCR and the expression array data (Table 5). However, probe sets for ESR2, INPP5F, FKBP5 and MYBBP1A, all of which had correct probe sequences, failed to show high correlation, perhaps as a result of the relatively small sample size used for the validation study.

### Gene Network Analysis

To further study the biological function and relationship among the top candidate genes identified in the genome-wide expression and cytotoxicity correlation studies, the Ingenuity Pathway Analysis (ingenuity.com/index.html) was used to perform network analysis. The focus was on genes with p values less than 10⁻⁵ for gemcitabine and 10⁻⁴ for AraC that were significant with both GCRMA and Fastlo normalization methods based on the genome-wide correlation studies between expression and GI₅₀ values for gemcitabine and AraC. Eighty-four candidate genes for gemcitabine and 75 for AraC were used to perform the analysis with the Ingenuity software program. A total of 9 and 20 networks were identified for gemcitabine and AraC, respectively. The “top” networks that had p-values <0.05 based on the Fisher's exact text were those associated with cell death, cancer, cell growth and proliferation, cell signaling, DNA replication, DNA recombination, DNA repair, and nucleic acid metabolism. Based on pathways with the highest number of significant candidate genes, cancer was identified as the major disease, and cell signaling and the cell cycle were the major molecular and cellular functions identified. These results are consistent with the use of these drugs to treat cancer.

### Alteration in Drug Sensitivity after Knockdown of NT5C3 and FKBP5

To confirm results obtained during the association study, two candidate genes were selected for functional validation with specific siRNA, followed by cytotoxicity studies. These genes were selected on the basis of the significance of the observed association and whether the gene was within or outside the cytidine analogue metabolism pathway. The first gene tested was a pathway gene, NT5C3, which encodes an enzyme that dephosphorylates active cytidine analogue metabolites to form the inactive parent drug. Although NT5C3 is a “pathway” gene, no previous reports had suggested that NT5C3 might play a role in sensitivity to cytidine analogues, although other members of the nucleotidase family, e.g., NT5C and NT5C1A, have been associated with clinical response (Borowiec et al. Acta. Biochim. Pol. (2006) 53:269-278; and Hunsucker et al. Pharmacol. Ther. (2005) 107:1-30). The association study had shown a positive correlation between the NT5C3 expression levels and gemcitabine LC₅₀ values (r=0.365, p=1.6×10⁻⁷, Bonferroni corrected p-value=0.0004), indicating that high expression of NT5C3 was associated with resistance to gemcitabine.

The second gene tested was one from outside of the metabolic pathway, FKBP5, which encodes a 51 kDa immunophilin. FKBP5 has been implicated in a variety of cellular actions, including steroid receptor maturation and as a binding partner for rapamycin (Baughman et al. Mol. Cell. Biol. (1995) 15:4395-4402; Cheung and Smith Mol. Endocrinol. (2000) 14:939-946; and Cheung-Flynn et al. J. Biol. Chem. (2003) 278:17388-17394). However, there had been no previous indication that FKBP5 might be involved in response to cytidine analogues. In contrast to NT5C3, expression levels for FKBP5 were negatively correlated with gemcitabine LC₅₀ values (r=−0.38), indicating that increased FKBP5 transcription resulted in increased sensitivity to these drugs. Three Affymetrix probe sets targeted FKBP5, although the sequence for one probe set was not specific (Table 5). Both specific probe sets showed highly significant associations with gemcitabine LC₅₀ values (p=4.12×10⁻⁸ and 4.15×10⁻⁸, respectively), providing additional evidence for the validity of the association. After Bonferroni correction, the p-values for the two FKBP5 probe sets remained significant (p=0.0001). However, neither NT5C3 nor FKBP5 were significantly associated with AraC cytotoxicity (p=3.47×10⁻³ for NT5C3 and p=1.26×10⁻² for FKBP5); although, as described subsequently, both proved to influence AraC response when tested functionally.

To confirm the possible functional significance of these two genes, siRNA knock down studies were performed, followed by cytotoxicity assays, using two tumor cell lines to confirm the results of the association study and to extend the results beyond the Human Variation Panel lymphoblastoid cell lines to include cancer cell lines. Although neither gene had displayed as significant an association with AraC as with gemcitabine cytotoxicity, functional studies were performed with both drugs using these two solid tumor cell lines. Although AraC is used clinically mainly to treat AML, previous studies have also used solid tumor cell lines for the analysis of both gemcitabine and AraC cytotoxicity (Heinemann et al. Cancer Res. (1988) 48:4024-4031; and Bergman et al. Biochem. Pharmacol. (2001) 61:1401-1408).

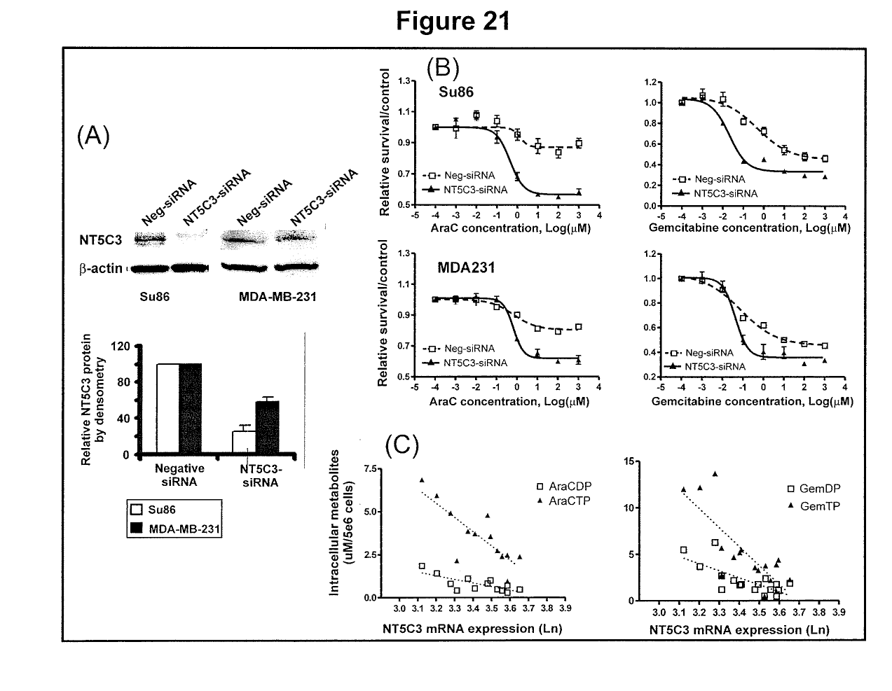

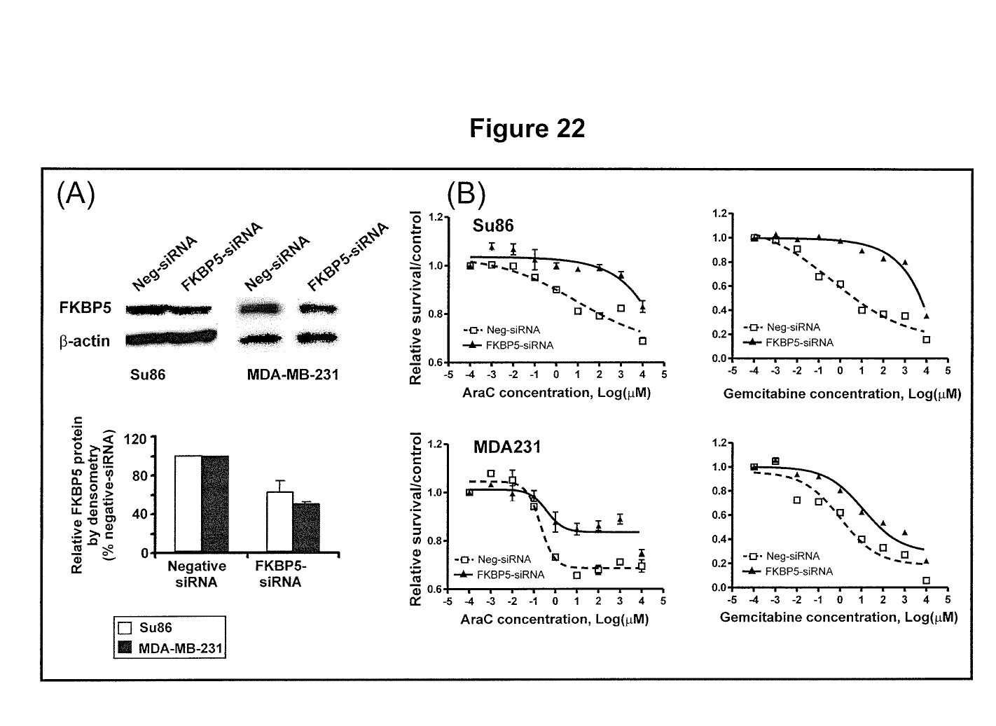

Two human cancer cell lines, the breast cancer MDA-MB-231 cell line and the pancreatic cancer SU86 cell line, were used for these functional studies since gemcitabine is used to treat both types of cancers and since NT5C3 and FKBP5 showed their most significant associations with LC₅₀ values for gemcitabine. Transient transfections were first performed with NT5C3 and FKBP5 specific siRNAs. Western blots verified that both genes were knocked down in both tumor cell lines (FIG. 21A and FIG. 22A). Gemcitabine and AraC cytotoxicity studies were then performed after transient transfection with siRNA. Down regulation of NT5C3 with specific siRNA shifted the dose response curve to the left, indicating increased sensitivity to gemcitabine in both cell lines (FIG. 21B). These results were consistent with those obtained during the genome-wide expression association study. In contrast, FKBP5 had demonstrated a negative correlation between level of expression and LC₅₀ values. That relationship also was confirmed by knockdown experiments performed with FKBP5 specific siRNA. Furthermore, down regulation of FKBP5 in the both tumor cell lines desensitized the cells to both gemcitabine and AraC (FIG. 22B).

### Characterization of NT5C3 and FKBP5 Cytotoxicity Mechanisms

The 5′-nucleotidases catalyze dephosphorylation of nucleoside monophosphates and, as a result, inactivate active phosphorylated drug metabolites (Hunsucker et al., supra). Both clinical and in vitro studies suggest that an increase in nucleotidase activity can reverse nucleoside analogue metabolic activation, resulting in drug resistance (Hunsucker et al., supra; Allegrini et al. Eur. J. Biochem. (2004) 271:4881-4891; and Wallden et al. J. Biol. Chem. (2007) 282:17828-17836). Furthermore, NT5C3 hydrolyzes pyrimidine monophosphates like the active metabolites of gemcitabine and AraC (Hunsucker et al., supra; and Galmarini et al. Haematologica (2005) 90:1699-1701). Therefore, the effect of NT5C3 on gemcitabine and AraC cytotoxicity could result from alterations in levels of active intracellular drug metabolites. Therefore, 14 sensitive and resistant lymphoblastoid cell lines were randomly selected for gemcitabine and for AraC to measure levels of active intracellular metabolites, including both the di- and the triphosphate metabolites for both drugs. An HPLC assay was developed to measure levels of intracellular phosphorylated metabolites with cell lysates isolated from these lymphoblastoid cell lines after three days of treatment with gemcitabine or AraC. The results indicated that concentrations of active metabolites, including AraCTP, GemDP and GemTP, were higher in sensitive than in resistant cell lines (p<0.05; Table 6). These results imply that genes within the cytidine analogue metabolic pathway, including the 5′-NTs, may contribute to the observed variation in response to these two cytidine analogues. Of equal importance was the fact that intracellular metabolite concentrations were inversely related to levels of NT5C3 mRNA (FIG. 21C). This result was consistent with the conclusion that higher NT5C3 expression in these cells was associated with AraC and gemcitabine dephosphorylation back to their “prodrug” forms, with decreased concentrations of active drug metabolites, resulting in drug resistance. These findings were also consistent with results obtained during the NT5C3-siRNA functional studies (FIG. 21B).

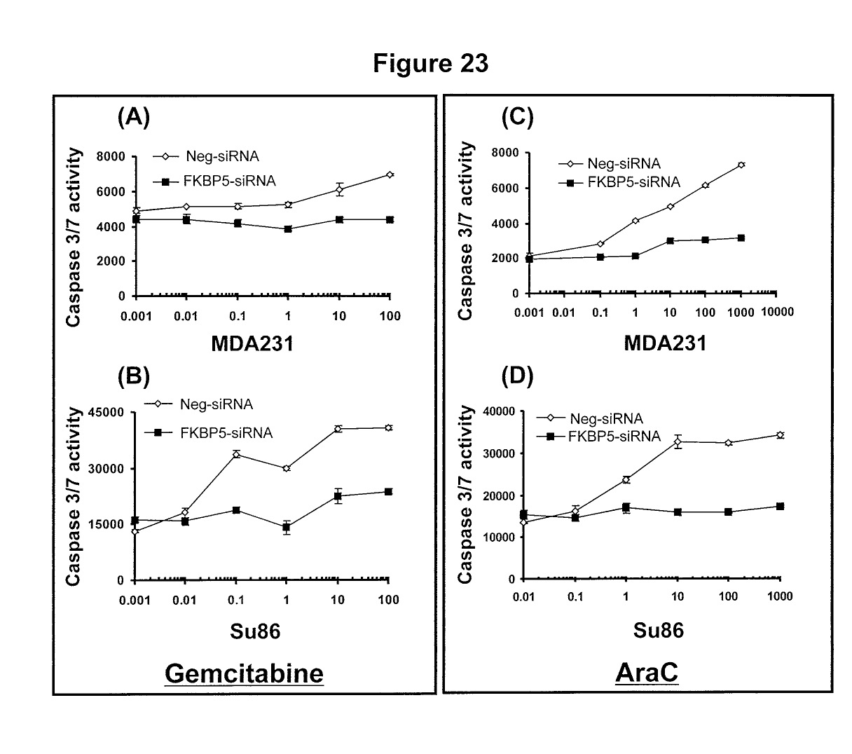

Potential mechanisms by which FKBP5 might influence sensitivity to gemcitabine and AraC were then tested. One possibility would involve the blockade of apoptosis signaling pathways as a result of FKBP5 knock-down. FKBP5 has been reported to be involved in apoptosis through a calcineurin-dependent pathway (Giraudier et al. Blood (2002) 100:2932-2940). To test that hypothesis, caspase-3/7 activity assays were performed to determine whether alterations in FKBP5 expression might influence apoptotic signaling. As shown in FIG. 23, caspase-3/7 activity in FKBP5 siRNA-treated cells was significantly decreased after treatment with increasing concentrations of both gemcitabine and AraC when compared with cells treated with negative siRNA, suggesting that activation of the apoptotic pathway was affected by the down-regulation of FKBP5 expression. Specific mechanisms by which FKBP5 might influence apoptosis will require future clarification.

TABLE 5
Significant genes with expression associated with gemcitabine and AraC cytotoxicity (GI₅₀ values).

| | | Number of | Correlation between | | | | | | |
|---|---|---|---|---|---|---|---|---|---|
| | | Specific | QRT-PCR and | Gemcitabine | | | AraC | | |
| Gene Name | Chromosome | Probe Sets | Microarray data | R value* | P-value | Q value | R value | P-value | Q value |
| ARL2BP | 16 | 1 | ** | −0.338 | 1.37E−06 | 1.41E−03 | −0.312 | 8.20E−06 | 5.79E−02 |
| C14orf169 | 14 | 11 | −0.77 | −0.313 | 8.45E−06 | 3.25E−03 | −0.285 | 4.84E−05 | 6.96E−02 |
| CENPB | 20 | 0 | ** | −0.349 | 5.52E−07 | 9.85E−04 | −0.248 | 4.37E−04 | 1.01E−01 |
| ESR2 | 14 | 7 | −0.26 | 0.355 | 3.61E−07 | 7.87E−04 | 0.253 | 3.40E−04 | 9.59E−02 |
| GCAT | 22 | 11 | 0.51 | −0.361 | 2.08E−07 | 5.83E−04 | −0.268 | 1.39E−04 | 8.92E−02 |
| INPP5F | 10 | 11 | −0.26 | −0.334 | 1.89E−06 | 1.69E−03 | −0.277 | 8.35E−05 | 8.92E−02 |
| MAP4K4 | 2 | 0 | ** | −0.329 | 2.57E−06 | 1.85E−03 | −0.264 | 1.74E−04 | 8.92E−02 |
| MGMT | 10 | 0 | ** | 0.338 | 1.30E−06 | 1.41E−03 | 0.26 | 2.21E−04 | 8.92E−02 |
| MYBBP1A | 17 | 9 | 0.04 | −0.319 | 5.65E−06 | 2.44E−03 | −0.31 | 9.24E−06 | 5.79E−02 |
| MYBBP1A | 17 | 10 | 0.29 | −0.291 | 3.72E−05 | 7.30E−03 | −0.255 | 2.97E−04 | 8.92E−02 |
| TLE4 | 9 | 11 | −0.73 | −0.327 | 3.11E−06 | 1.85E−03 | −0.264 | 1.77E−04 | 8.92E−02 |
| TRRAP | 7 | 1 | ** | −0.312 | 8.85E−06 | 3.26E−03 | −0.27 | 1.26E−04 | 8.92E−02 |
| ZNF278 | 22 | 9 | −0.7 | −0.319 | 5.67E−06 | 2.44E−03 | −0.338 | 1.20E−06 | 2.48E−02 |
| TPMT (AraC) | 6 | 6 | ** | | | | 0.301 | 1.72E−05 | 5.93E−02 |
| FKBP5 (gemcitabine) | 6 | 11 | −0.33 | −0.38 | 4.12E−08 | 2.04E−04 | | | |
| FKBP5 (gemcitabine) | 6 | 10 | −0.4 | −0.38 | 4.15E−08 | 2.04E−04 | | | |
| FKBP5 (gemcitabine) | | 0 | ** | −0.35 | 3.47E−07 | 7.8E−04 | | | |
| NT5C3 (gemcitabine) | 7 | 11 | −0.55 | 0.365 | 1.60E−07 | 5.23E−04 | | | |

*R values represent Pearson correlation coefficients; P-values are listed for these correlations; and Q values represent false discovery.

TABLE 6
Intracellular metabolites determined by HPLC in lymphoblastoid
cells after treatment with AraC (A) or gemcitabine (B)

| (A) | AraC GI₅₀ (μM) | | AraCDP | | AraCTP | |
|---|---|---|---|---|---|---|
| Cell sample | Resistant | Sensitive | Resistant | Sensitive | Resistant | Sensitive |
| 1 | 76.6 | 0.65 | 0.83 | 1.9 | 4.78 | 6.86 |
| 2 | 7.2 | 0.24 | 0.28 | 1.4 | 0.95 | 5.94 |
| 3 | 26.0 | 0.96 | 1.34 | 0.8 | 2.64 | 4.92 |
| 4 | 51.3 | 1.06 | 0.46 | 1.0 | 2.39 | 3.56 |
| 5 | 20.4 | 1.99 | 0.41 | 0.4 | 2.39 | 2.16 |
| 6 | 20.0 | 2.73 | 0.49 | 1.1 | 2.73 | 3.87 |
| 7 | 13.8 | 2.77 | 0.70 | 0.5 | 2.47 | 3.72 |
| Average ± SEM | 30.8 ± 8.7 | 1.49 ± 0.36 | 0.65 ± 0.13 | 1.02 ± 0.18 | 2.62 ± 0.40 | 4.43 ± 0.56 |
| p-value | 0.02* | | 0.15 | | 0.03* | |
| (B) | Gemcitabine GI₅₀ (μM) | | GemDP | | GemTP | |
| Cell sample | Resistant | Sensitive | Resistant | Sensitive | Resistant | Sensitive |
| 1 | 32.2 | 7.32 | 0.5 | 2.7 | 0.5 | 5.7 |
| 2 | 58.6 | 3.88 | 1.2 | 5.5 | 3.6 | 12.0 |
| 3 | 34.3 | 1.24 | 0.5 | 3.7 | 1.0 | 12.2 |
| 4 | 40.7 | 6.43 | 1.1 | 6.3 | 4.4 | 13.7 |
| 5 | 80.7 | 12.17 | 1.9 | 1.2 | 2.3 | 2.8 |
| 6 | 102.7 | 12.02 | 1.2 | 2.2 | 2.2 | 4.7 |
| 7 | 273.1 | 13.42 | 2.4 | 1.8 | 3.8 | 5.5 |
| Average ± SEM | 80.5 ± 26.8 | 7.61 ± 1.58 | 1.34 ± 0.24 | 3.14 ± 0.66 | 2.71 ± 0.51 | 7.49 ± 1.55 |

| | | | |
|---|---|---|---|
| p-value | 0.03* | 0.03* | 0.015* |

*indicates p < 0.05 between sensitive and resistant cell lines.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

1. A method for evaluating cellular response to a therapeutic agent, said method comprising:
(a) contacting said agent with a panel of cell lines from a plurality of individuals, said cell lines characterized for genetic variation in one or more genes encoding polypeptides within the biochemical pathway for metabolism of the agent; and
(b) correlating the response of the cell lines with the genetic variation.

2. The method of claim 1, wherein said cell line panel comprises cell lines from multiple ethnicities.

3. The method of claim 2, wherein said cell line panel comprises at least 50 cell lines from Caucasian-American individuals, at least 50 cell lines from African-America individuals, and at least 50 cell lines from Han Chinese-American individuals.

4. The method of claim 2, wherein said cell line panel comprises at least 100 cell lines from Caucasian-American individuals, at least 100 cell lines from African-America individuals, and at least 100 cell lines from Han Chinese-American individuals.

5. The method of claim 1, further comprising characterizing in said cell lines genetic variation in linkage disequilibrium with the genetic variation in one or more genes encoding polypeptides within the biochemical pathway of said agent.

6. The method of claim 5, comprising characterizing said cell lines for genetic variation in at least 100 genes.

7. The method of claim 5, comprising characterizing said cell lines for genetic variation in at least 1,000 genes.

8. (canceled)

9. The method of claim 1, wherein said cell lines are further characterized for levels of one or more metabolites.

10. The method of claim 1, wherein said cell lines are further characterized for levels of at least 100 metabolites.

11. The method of claim 1, wherein said cell lines are further characterized for levels of at least 1,000 metabolites.

12. (canceled)

13. The method of claim 1, wherein said cell lines are further characterized for the levels of one or more polypeptides.

14. The method of claim 1, wherein said cell lines are further characterized for the levels of at least 100 polypeptides.

15. The method of claim 1, wherein said cell lines are further characterized for the levels of at least 1,000 polypeptides.

16. (canceled)

17. The method of claim 1, wherein said cell lines are further characterized for the levels of one or more mRNAs.

18. The method of claim 1, wherein said cell lines are further characterized for the levels of at least 100 mRNAs.

19. The method of claim 1, wherein said cell lines are further characterized for the levels of at least 1,000 mRNAs.

20. (canceled)

21. The method of claim 1, wherein said therapeutic agent is a cytotoxic agent.

22. The method of claim 1, wherein said therapeutic agent is a pyrimidine analog.

23. The method of claim 1, wherein said therapeutic agent is AraC.

24. The method of claim 1, wherein said therapeutic agent is gemcitabine.

25-44. (canceled)
